(19) United States
(12) Patent Application Publication
(10) Pub. No.: US 2026/0302079 A1
(43) Pub. Date: Oct. 1, 2026

(54) MULTILAYER CERAMIC ELECTRONIC COMPONENT AND METHOD OF MANUFACTURING SAME

(71) Applicant: TAIYO YUDEN CO., LTD., Tokyo (JP)

(72) Inventors: Ayumi SHIROTA, Tokyo (JP); Shota YAMANAKA, Tokyo (JP); Tomoki SAKAI, Tokyo (JP); Tomoaki NAKAMURA, Tokyo (JP); Satoshi KOBAYASHI, Tokyo (JP)

(21) Appl. No.: 19/549,500

(22) Filed: Feb. 25, 2026

(30) Foreign Application Priority Data
Mar. 28, 2025 (JP) 2025-057128

(51) Int. Cl. H01G 4/30; H01G 4/232

(52) U.S. Cl. CPC H01G 4/30; H01G 4/2325

(57) ABSTRACT

A multilayer ceramic electronic component includes: an element body having a pair of end surfaces that face each other in a first direction and at which a plurality of laminated internal electrodes are alternately exposed; a pair of metal base layers each including a first metal layer and a second metal layer; and a pair of plating layers. In a plan view of a surface having the first metal layer, an outer edge of a corresponding one of the plating layers has a curved shape protruding from an end surface side toward a center portion of the element body, and a linear distance E1 from an intersection point A to an intersection point A′ in the first direction and a linear distance E2 from an outermost point B to an outermost point B′ satisfy Equation 1 below,

$$E 1 \neq E 2 \qquad Equation 1$$

where E1>0 and E2>0.

### CROSS-REFERENCE TO RELATED APPLICATIONS

This application is based on and claims priority to Japanese Patent Application No. 2025-057128, filed on Mar. 28, 2025, the entire contents of which are incorporated herein by reference.

### TECHNICAL FIELD

The present disclosure relates to a multilayer ceramic electronic component and a method of manufacturing the same.

### BACKGROUND

With the widespread use of hybrid vehicles (HEV) and electric vehicles (EV), the number of electronic components mounted in automobiles has increased dramatically. Thus, similar to various electronic devices such as personal computers and smart phones, there is a demand for high-density mounting of multilayer ceramic electronic components such as multilayer ceramic capacitors (MLCCs), and further improvement in the reliability of multilayer ceramic electronic components is required.

For example, a highly-reliable multilayer ceramic capacitor that is highly moisture resistant and that has a high thermo-mechanical strength (flexural strength) is known. The multilayer ceramic capacitor includes: a laminated body in which inner electrodes and dielectric layers are laminated; and external electrodes disposed on a surface of the laminated body so as to be connected to the inner electrodes. In the multilayer ceramic capacitor, each of the external electrodes includes: a first external electrode layer containing Ni and disposed on each main surface of the laminated body; and a second external electrode layer containing a glass component and Cu, covering a region including an end surface of the laminated body to which some of the inner electrodes extend and an end portion on the end surface side of the first outer electrode layer, joined to the first external electrode layer, and electrically connected to the some of the internal electrodes. See Patent Document 1, for example.

In a case where external electrode layers provided at both end portions of a multilayer ceramic electronic component are shaped such that an inner edge of each of the external electrode layers, which is located inward of an outer edge of an element body of the multilayer ceramic electronic component, extends linearly across the widthwise direction in a plan view, it is known that a tombstone phenomenon (which is also referred to as a Manhattan phenomenon) occurs when the multilayer ceramic electronic component is mounted on a wiring pattern.

### RELATED-ART DOCUMENTS

### Patent Documents

Patent Document 1: Japanese Laid-open Patent Application Publication No. 2017-022365
Patent Document 2: Japanese Laid-open Patent Application Publication No. 2002-280254
Patent Document 3: Japanese Laid-open Patent Application Publication No. 2017-216268

### SUMMARY OF THE INVENTION

According to one embodiment of the present disclosure, a multilayer ceramic electronic component includes: an element body in which a plurality of internal electrodes and a plurality of dielectric layers containing a ceramic as a main component are alternately laminated, and that has a pair of end surfaces and four surfaces connected to the pair of end surfaces, wherein the pair of end surfaces face each other in a first direction and the plurality of laminated internal electrodes are alternately exposed at the pair of end surfaces; a pair of metal base layers extending from the pair of end surfaces to portions of the four surfaces; and a pair of plating layers covering the pair of metal base layers. Each of the pair of metal base layers includes a first metal layer disposed on a portion of at least one surface of the four surfaces of the element body, and a second metal layer continuously covering a region extending from a corresponding one of the end surfaces of the element body to a portion on an end surface side of the first metal layer. In a plan view of the at least one surface of the element body having the first metal layer, the first metal layer has a first region covered by the second metal layer and a second region not covered by the second metal layer, an outer edge of a corresponding one of the plating layers has a curved shape protruding from an end surface side toward a center portion of the element body, and when an intersection point between each of outer edges of the element body, facing in a second direction perpendicular to the first direction, and an outer edge of the corresponding one of the plating layers is defined as an intersection point, an intersection point between each of the outer edges of the element body, facing in the second direction, and a boundary between the first region and the second region is defined as an intersection point A′, an imaginary straight line parallel to the first direction and passing through a midpoint, in the second direction, of the corresponding one of the plating layers at a position where the corresponding one of the plating layers has a maximum length L in the second direction is defined as an imaginary straight line f1, an outermost point of the corresponding one of the plating layers on the imaginary straight line f1 on the element body is defined as an outermost point B, and an intersection point between the imaginary straight line f1 and the boundary between the first region and the second region is defined as an intersection point B′, a linear distance E1 from the intersection point A to the intersection point A′ in the first direction and a linear distance E2 from the outermost point B to the outermost point B′ satisfy Equation 1 below,

$$E 1 \neq E 2 \qquad Equation l$$

where E1>0 and E2>0.

### BRIEF DESCRIPTION OF THE DRAWINGS

FIG. 1 is a partial cross-sectional perspective view illustrating an example of a multilayer ceramic capacitor according to a first embodiment;

FIG. 2 is a cross-sectional view illustrating a cross section taken along the line II-II of FIG. 1;

FIG. 3 is a cross-sectional view illustrating a cross section taken along the line III-III of FIG. 1;

FIG. 4A is a plan view illustrating an example of the multilayer ceramic capacitor according to the first embodiment;

FIG. 4B is a schematic explanatory view illustrating the relationship between first metal layers and second metal layers, in which plating layers illustrated in FIG. 4A are omitted;

FIG. 4C is a schematic explanatory view illustrating the size of each part illustrated in FIG. 4A;

FIG. 5A is a schematic top view when the multilayer ceramic capacitor according to the first embodiment is mounted by being fixed to a land part of a wiring pattern with solder;

FIG. 5B is a schematic top view when the multilayer ceramic capacitor according to the first embodiment is mounted by being fixed to the land part of the wiring pattern with the solder;

FIG. 6 is a schematic side view when the multilayer ceramic capacitor according to the first embodiment is mounted by being fixed to the land part of the wiring pattern with the solder;

FIG. 7A is a plan view illustrating an example of a multilayer ceramic capacitor according to a second embodiment;

FIG. 7B is a schematic explanatory view illustrating the relationship between the first metal layers and the second metal layers, in which the plating layers illustrated in FIG. 7A are omitted;

FIG. 8A is a plan view illustrating an example of a multilayer ceramic capacitor according to a third embodiment;

FIG. 8B is a schematic explanatory view illustrating the relationship between the first metal layers and the second metal layers, in which the plating layers illustrated in FIG. 8A are omitted;

FIG. 9A is a plan view illustrating an example of a multilayer ceramic capacitor according to a fourth embodiment;

FIG. 9B is a schematic explanatory view illustrating the relationship between the first metal layers and the second metal layers, in which the plating layers illustrated in FIG. 9A are omitted;

FIG. 10A is a plan view illustrating an example of a multilayer ceramic capacitor according to a fifth embodiment;

FIG. 10B is a schematic explanatory view illustrating the relationship between the first metal layers and the second metal layers, in which the plating layers illustrated in FIG. 10A are omitted;

FIG. 11A is a plan view illustrating an example of a multilayer ceramic capacitor according to a sixth embodiment;

FIG. 11B is a schematic explanatory view illustrating the relationship between the first metal layers and the second metal layers, in which the plating layers illustrated in FIG. 11A are omitted;

FIG. 12A is a plan view illustrating an example of a multilayer ceramic capacitor according to a seventh embodiment;

FIG. 12B is a schematic explanatory view illustrating the relationship between the first metal layers and the second metal layers, in which the plating layers illustrated in FIG. 12A are omitted;

FIG. 13A is a plan view illustrating an example of a multilayer ceramic capacitor according to an eighth embodiment;

FIG. 13B is a schematic explanatory view illustrating the relationship between the first metal layers and the second metal layers, in which the plating layers illustrated in FIG. 13A are omitted;

FIG. 14A is a plan view illustrating an example of a multilayer ceramic capacitor according to a ninth embodiment;

FIG. 14B is a schematic explanatory view illustrating the relationship between the first metal layers and the second metal layers, in which the plating layers illustrated in FIG. 14A are omitted;

FIG. 15A is a plan view illustrating an example of a multilayer ceramic capacitor according to a tenth embodiment;

FIG. 15B is a schematic explanatory view illustrating the relationship between the first metal layers and the second metal layers, in which the plating layers illustrated in FIG. 15 are omitted;

FIG. 15C is a cross-sectional view illustrating a cross section taken along the imaginary straight line f1 of FIG. 15A;

FIG. 16A is a plan view illustrating an example of a multilayer ceramic capacitor according to a comparative embodiment;

FIG. 16B is a schematic explanatory view illustrating the relationship between first metal layers and second metal layers, in which plating layers illustrated in FIG. 16A are omitted;

FIG. 16C is a schematic explanatory view illustrating the size of each part illustrated in FIG. 16A.

FIG. 17A is a schematic top view when the multilayer ceramic capacitor according to the comparative embodiment is mounted by being fixed to a land part of a wiring pattern with solder;

FIG. 17B is a schematic top view when the multilayer ceramic capacitor according to the comparative embodiment is mounted by being fixed to the land part of the wiring pattern with the solder;

FIG. 18A is a schematic side view when the multilayer ceramic capacitor according to the comparative embodiment is mounted by being fixed to the land part of the wiring pattern with the solder;

FIG. 18B is a schematic side view when the multilayer ceramic capacitor according to the comparative embodiment is mounted by being fixed to the land part of the wiring pattern with the solder;

FIG. 19 is a flowchart illustrating an example of a manufacturing method of a multilayer ceramic electronic component according to an embodiment of the present disclosure;

FIG. 20 is a flowchart illustrating an example of an element body preparing step of the method of manufacturing the multilayer ceramic electronic component according to the embodiment of the present disclosure;

FIG. 21 is a flowchart illustrating an example of a metal base layer forming step of the method of manufacturing the multilayer ceramic electronic component according to the embodiment of the present disclosure;

FIG. 22A is a schematic plan view illustrating an example of a step of covering with a first covering member in the metal base layer forming step of the method of manufacturing the multilayer ceramic electronic component according to the embodiment of the present disclosure;

FIG. 22B is a schematic plan view illustrating an example of a step of applying a first metal paste in the metal base layer forming step of the method of manufacturing the multilayer ceramic electronic component according to the embodiment of the present disclosure;

FIG. 22C is a schematic plan view illustrating an example of a step of sintering the first metal paste in the metal base layer forming step of the method of manufacturing the multilayer ceramic electronic component according to the embodiment of the present disclosure;

FIG. 23 is a flowchart illustrating an example of the metal base layer forming step of the method of manufacturing the multilayer ceramic electronic component according to the embodiment of the present disclosure;

FIG. 24A is a schematic plan view illustrating an example of a step of covering with a second covering member in the metal base layer forming step of the method of manufacturing the multilayer ceramic electronic component according to the embodiment of the present disclosure;

FIG. 24B is a schematic plan view illustrating an example of a step of applying a second metal paste in the metal base layer forming step of the method of manufacturing the multilayer ceramic electronic component according to the embodiment of the present disclosure;

FIG. 24C is a schematic plan view illustrating an example of a step of sintering the second metal paste in the metal base layer forming step of the method of manufacturing the multilayer ceramic electronic component according to the embodiment of the present disclosure;

FIG. 24D is a schematic plan view illustrating an example of a state in which the second covering member is peeled off after the step of sintering the second metal paste in the metal base layer forming step of the method of manufacturing the multilayer ceramic electronic component according to the embodiment of the present disclosure;

FIG. 24E is a plan view illustrating an example of a state in which the first covering member and the second covering member are peeled off after the metal base layer forming step is performed; and

FIG. 25 is a schematic plan view illustrating an example of a plating layer forming step of the method of manufacturing the multilayer ceramic electronic component according to the embodiment of the present disclosure.

### DESCRIPTION OF THE PREFERRED EMBODIMENTS

A multilayer ceramic electronic component is surface-mounted on the surface of a circuit board by fixing a pair of external electrodes to a land part of a wiring pattern by soldering. In order to mount the ceramic electronic component at a high density, accurate placement of the ceramic electronic component on the land part of the wiring pattern is required. However, with the shapes of conventional external electrodes, accurate fixation to the land part of the wiring pattern is difficult.

It is an object of the present disclosure to provide a multilayer ceramic electronic component that can suppress excess solder wicking and that can be fixed to a land part of a wiring pattern by soldering with an accurate mounting orientation and posture.

As a result of intensive studies on a multilayer ceramic electronic component that can suppress excess solder wicking and that can be fixed to a land part of a wiring pattern by soldering with an accurate mounting orientation and posture, the present inventors have arrived at the following embodiments.

The embodiments of the present disclosure will be described in detail below. The embodiments are not limited by the following description, and may be appropriately modified without departing from the gist of the present disclosure. In the present specification, the term “to” indicating a numerical range means to include the values specified before and after the term as the lower limit and the upper limit, unless otherwise particularly noted.

Further, in the present specification and the drawings, components having substantially the same functional configurations are denoted by the same reference numerals, and duplicate descriptions thereof may be omitted. Further, in the present specification and the drawings, the number, the position, the size, the shape, and the like of each component are not limited to those specified in the embodiments of the present disclosure, and may be preferable number, position, size, shape, and the like in the embodiments of the present disclosure. In the drawings, an X-axis, a Y-axis, and a Z-axis that are orthogonal to each other are indicated as appropriate. The X-axis, the Y-axis, and the Z-axis define a fixed coordinate system that is fixed to a multilayer ceramic electronic component.

Further, in the present specification, the terms “same”, “identical”, “equal (=)”, and the like can include not only cases of exact match but also errors within a range that allows effects of the present disclosure to be obtained.

### Multilayer Ceramic Electronic Component

### First Embodiment

A multilayer ceramic electronic component according to a first embodiment includes: an element body in which a plurality of internal electrodes and a plurality of dielectric layers containing a ceramic as a main component are alternately laminated, and that has a pair of end surfaces and four surfaces connected to the pair of end surfaces, wherein the pair of end surfaces face in a first direction and the plurality of laminated internal electrodes are alternately exposed at the pair of end surfaces; a pair of metal base layers extending from the pair of end surfaces to portions of the four surfaces; and a pair of plating layers covering the pair of metal base layers. Each of the pair of metal base layers includes a first metal layer disposed on a portion of at least one surface of the four surfaces of the element body, and a second metal layer continuously covering a region extending from a corresponding one of the end surfaces of the element body to a portion on an end surface side of the first metal layer. The multilayer ceramic electronic component according to the first embodiment may further include other layers or members as necessary.

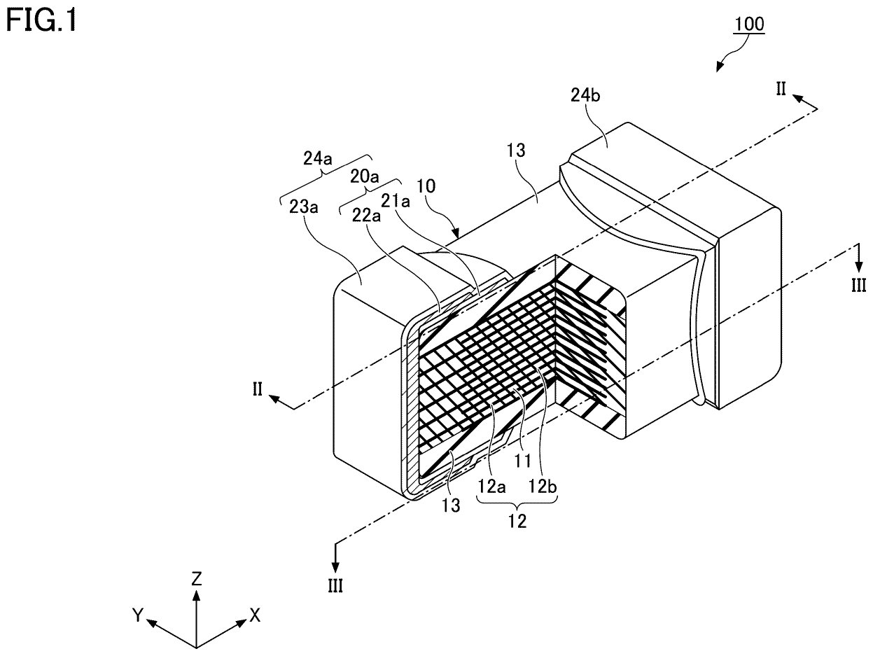

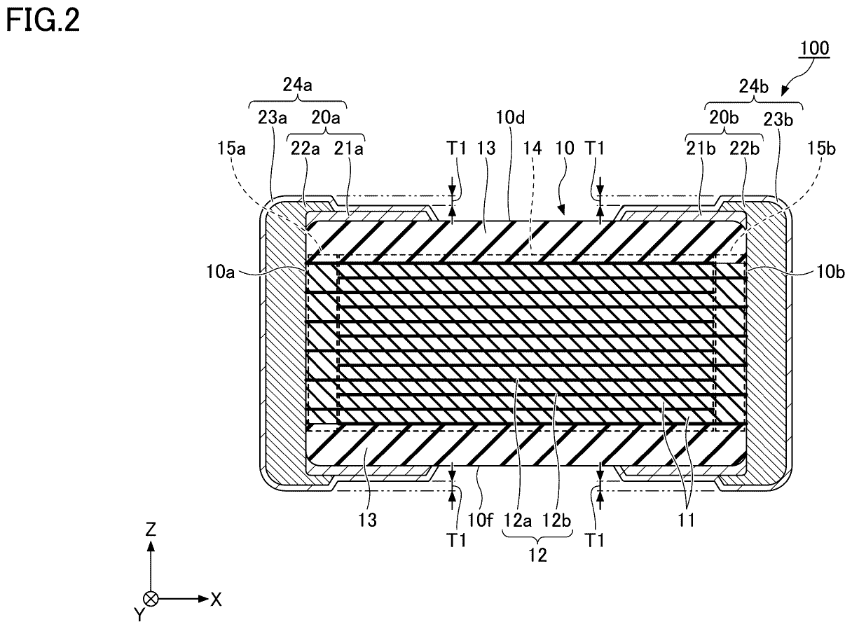

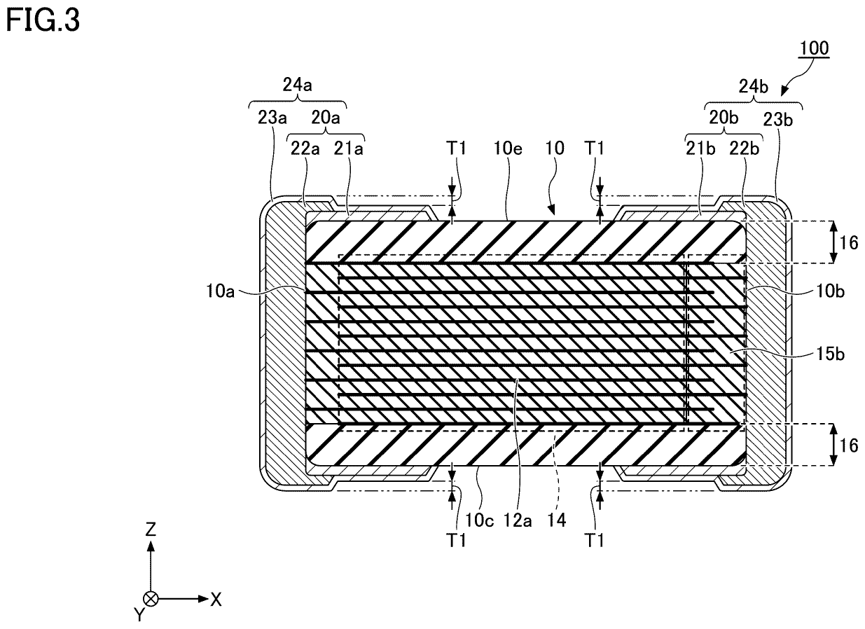

FIG. 1 is a partial cross-sectional perspective view illustrating an example of a multilayer ceramic capacitor according to the first embodiment. FIG. 2 is a cross-sectional view illustrating a cross section taken along the line II-II of FIG. 1. FIG. 3 is a cross-sectional view illustrating a cross section taken along the line III-III of FIG. 1.

A multilayer ceramic capacitor 100 includes: a substantially rectangular-parallelepiped-shaped element body 10 having a pair of end surfaces 10a and 10b facing in a first direction, and four surfaces 10c, 10d, 10e, and 10f connected to the end surfaces 10a and 10b; metal base layers 20a and 20b including first metal layers 21a and 21b and second metal layers 22a and 22b; and plating layers 23a and 23b. The metal base layer 20a and the plating layer 23a function as an external electrode 24a and the metal base layer 20b and the plating layer 23b function as an external electrode 24b.

A surface of the element body 10 facing a circuit board when the multilayer ceramic capacitor 100 is mounted on the circuit board is sometimes referred to as a lower surface, but any of the four surfaces 10c, 10d, 10e, and 10f connected to the end surfaces 10a and 10b may serve as a surface facing the circuit board. However, in a case where the metal base layers 20a and 20b are provided on only one surface of the four surfaces 10c, 10d, 10e, and 10f of the element body 10, the surface having the metal base layers 20a and 20b serves as a surface facing the circuit board when the multilayer ceramic capacitor 100 is mounted on the circuit board.

The first metal layers 21a and 21b are disposed on portions of at least one surface of the four surfaces 10c, 10d, 10e, and 10f of the element body 10. Note that the first metal layer 21a of the metal base layer 20a and the first metal layer 21b of the metal base layer 20b are spaced apart from each other.

The metal base layers 20a and 20b are provided on the end surfaces 10a and 10b of the element body 10, which are the pair of end surfaces facing in the first direction. The metal base layer 20a extends from the end surface 10a to the four adjacent surfaces. The metal base layer 20b extends from the end surface 10b to the four adjacent surfaces. Note that the metal base layer 20a and the metal base layer 20b are spaced apart from each other.

The metal base layers 20a and 20b include the first metal layers 21a and 21b disposed on portions of at least one surface of the four surfaces of the element body 10, and the second metal layers 22a and 22b. The second metal layer 22a continuously covers a region extending from the end surface 10a of the element body 10 to a portion on the end surface 10a side of the first metal layer 21a, and the second metal layer 22b continuously covers a region extending from the end surface 10b of the element body 10 to a portion on the end surface 10b side of the first metal layer 21b.

Further, the plating layers 23a and 23b are disposed on the metal base layers 20a and 20b. Specifically, the plating layer 23a is disposed on exposed surfaces of the first metal layer 21a and the second metal layer 22a, and the plating layer 23b is disposed on exposed surfaces of the first metal layer 21b and the second metal layer 22b. Note that the plating layer 23a and the plating layer 23b are spaced apart from each other.

The plating layers 23a and 23b are disposed such that the metal base layers 20a and 20b are not exposed. Preferably, each of the plating layers 23a and 23b has a uniform average thickness. In particular, the average thickness of each of the plating layers 23a and 23b located on the first metal layers 21a and 21b is preferably equal to the average thickness of each of the plating layers 23a and 23b located on the second metal layers 22a and 22b. Because the plating layers 23a and 23b each having a uniform average thickness are disposed to conform to the first metal layers 21a and 21b and the second metal layers 22a and 22b, the outer periphery of each of the plating layers 23a and 23b is substantially the same as the outer periphery of each of the metal base layers 20a and 20b including the first metal layers 21a and 21b and the second metal layers 22a and 22b. In a plan view of at least one surface having the first metal layers 21a and 21b, outer edges of the plating layers 23a and 23b have curved shapes projecting from the end surface 10a side and the end surface 10b side toward a center portion of the element body 10.

As used herein, the expression “the average thickness of each of the plating layers 23a and 23b located on the first metal layers 21a and 21b is equal to the average thickness of each of the plating layers 23a and 23b located on the second metal layers 22a and 22b” can include an error of about +1 μm.

Each of the pair of end surfaces 10a and 10b and the four surfaces 10c, 10d, 10e, and 10f of the element body 10 is formed as a flat surface. The flat surface in the present disclosure is not required to be strictly flat as long as it is recognized as flat when viewed as a whole, and includes, for example, a surface having a minute uneven shape, a surface having a gently curved shape in a predetermined range, and the like.

In the multilayer ceramic electronic component according to the first embodiment, as an example, the metal base layer 20a and the plating layer 23a are used as an anode, and the metal base layer 20b and the plating layer 23b are used as a cathode. It is preferable to provide a visual distinction such as a marker, such that the plating layer 23a on the anode side and the plating layer 23b on the cathode side are visually distinguishable from each other.

A direction in which the pair of end surfaces 10a and 10b face is defined as the first direction. The first direction is an X-axis direction. Further, a direction perpendicular to the first direction is defined as a second direction. The second direction is a Y-axis direction, which is a widthwise direction of internal electrodes 12. Further, a direction perpendicular to the first direction and perpendicular to the second direction is defined as a third direction. The third direction is a Z-axis direction, which is a lamination direction of dielectric layers 11 and the internal electrodes 12. The X-axis, the Y-axis, and the Z-axis are orthogonal to each other.

The element body 10 has a configuration in which the dielectric layers 11, functioning as a dielectric and containing a ceramic as a main component, and the internal electrodes 12 are alternately laminated. The internal electrodes 12 include a plurality of first internal electrodes 12a and a plurality of second internal electrodes 12b. The first internal electrodes 12a and the second internal electrodes 12b are alternately laminated. The edges of the first internal electrodes 12a extend to a surface of the element body 10 on which the metal base layer 20a is disposed, that is, to the end surface 10a in the example of FIG. 1 to FIG. 3. The edges of the second internal electrodes 12b extend to a surface of the element body 10 on which the metal base layer 20b is disposed, that is, to the end surface 10b in the example of FIG. 1 to FIG. 3. Thus, the first internal electrodes 12a and the second internal electrodes 12b are alternately electrically connected to the metal base layer 20a and the metal base layer 20b. Therefore, the multilayer ceramic capacitor 100 has a configuration in which capacitor units are laminated.

In a laminate of the dielectric layers 11 and the internal electrodes 12, internal electrodes 12 are disposed on the outermost layers in the lamination direction, and the outer surfaces of the laminate in the lamination direction, which are the upper surface and the lower surface in the example of FIG. 1 to FIG. 3, are covered by a cover layer 13. The cover layer 13 contains a ceramic as a main material. For example, the composition of the cover layer 13 may be the same as or different from the composition of the dielectric layers 11. The present disclosure is not limited to the configuration illustrated in FIG. 1 to FIG. 3 as long as the first internal electrodes 12a and the second internal electrodes 12b are exposed at different regions among the surfaces of the laminate and are electrically connected to the different metal base layers 20a and 20b. The different regions among the surfaces of the laminate may be surface regions included in facing surfaces of the laminate, may be surface regions included in adjacent surfaces of the laminate, or may be different surface regions included in the same surface of the laminate. As long as the different metal base layers 20a and 20b are spaced apart from each other, the metal base layers 20a and 20b may extend from surface(s) of the laminate, which include surface regions at which the first internal electrodes 12a and the second internal electrodes 12b are exposed, to any other surface.

The size of the multilayer ceramic capacitor 100 is not particularly limited. For example, the size of the multilayer ceramic capacitor 100 may be 1.6 mm in length, 0.8 mm in width, and 0.8 mm in height, may be 2.0 mm in length, 1.25 mm in width, and 1.25 mm in height, may be 3.2 mm in length, 1.6 mm in width, and 1.6 mm in height, may be 3.2 mm in length, 2.5 mm in width, and 2.5 mm in height, or may be 4.5 mm in length, 3.2 mm in width, and 2.5 mm in height. However, the above-listed sizes of the multilayer ceramic capacitor 100 are merely examples, and the size of the multilayer ceramic capacitor 100 is not limited to the above-listed sizes. The size of the multilayer ceramic capacitor 100 may be, for example, length>width≥height, width>length≥height, height>length≥width, or height>width≥length. For example, the length represents a dimension in the X-axis direction, the width represents a dimension in the Y-axis direction, and the height represents a dimension in the Z-axis direction.

As described above, the multilayer ceramic capacitor 100 according to the first embodiment of the present disclosure includes the plurality of dielectric layers 11 laminated in the third direction, the plurality of internal electrodes 12 each disposed between adjacent dielectric layers 11 in the third direction, and the pair of metal base layers 20a and 20b. The pair of metal base layers 20a and 20b are disposed on the pair of end surfaces 10a and 10b of the element body 10 facing in the first direction, and are electrically connected to the internal electrodes 12. The dielectric layers 11, the internal electrodes 12, the metal base layers 20a and 20b, and the plating layers 23a and 23b will be described below.

### <Dielectric Layers 11>

The dielectric layers 11 contain a ceramic as a main component. The ceramic contained in the dielectric layers 11 is, for example, a compound having a perovskite structure and represented by a general formula ABO_{3-α} (0≤α≤1). The dielectric layers 11 may further contain an additive as necessary.

When the compound having the perovskite structure has a stoichiometric composition, α, which indicates the amount of deviation from the stoichiometric composition, is 0, and the compound having the perovskite structure is represented by a general formula ABO₃. In the compound having the perovskite structure represented by the above general formula, a may be greater than 0 and 1 or less. That is, the compound having the perovskite structure and represented by the above general formula may be more oxygen-deficient than the stoichiometric composition.

In the general formula ABO_{3-α}, “A” is preferably one or more elements selected from the group consisting of barium (Ba), strontium (Sr), calcium (Ca), and magnesium (Mg). In the general formula ABO_{3-α}, “B” is preferably one or more elements selected from the group consisting of titanium (Ti), zirconium (Zr), and hafnium (Hf). In the compound having the perovskite structure and represented by the general formula ABO_{3-α}, the elements “A” and “B” are located at the A site and the B site of the perovskite structure, respectively.

Specific examples of the compound having the perovskite structure include one or more selected from the group consisting of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr₂O₃ (0≤x≤1, 0≤y≤1, 0≤z≤1) forming a perovskite structure.

Examples of Ba_{1-x-y}CaₓSr_{y}Ti_{1-z}Zr₂O₃ include strontium barium titanate, calcium barium titanate, barium zirconate, barium zirconate titanate, calcium zirconate titanate, calcium barium zirconate titanate, and the like. The compound having the perovskite structure may have an oxygen deficiency regardless of whatever material it is.

The dielectric layers 11 preferably contain barium titanate as the compound having the perovskite structure because barium titanate has especially excellent dielectric characteristics. The dielectric layers 11 may contain barium titanate as a main component or may consist only of barium titanate. Barium titanate has excellent dielectric characteristics, such as an extremely high relative dielectric constant, low dielectric loss, and the like. Therefore, the capacitance of the multilayer ceramic capacitor 100 can be increased when the dielectric layers 11 contain barium titanate as the compound having the perovskite structure.

In the present specification, the term “main component” refers to a component present in the largest amount in terms of molar ratio, among the contained components.

The dielectric layers 11 may contain, as a main component, the compound having the perovskite structure. For example, the dielectric layers 11 may contain the compound having the perovskite structure in an amount of 50% by mole or more or 90% by mole or more, or may consist only of the compound having the perovskite structure.

The dielectric layers 11 may contain an additive as an optional component. The additive contained in the dielectric layers 11 is not particularly limited. Examples of the additive include: oxides containing one or more elements selected from the group consisting of zirconium (Zr), magnesium (Mg), manganese (Mn), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); oxides containing one or more elements selected from the group consisting of cobalt (Co), nickel (Ni), lithium (Li), boron (B), sodium (Na), potassium (K), and silicon (Si); glass containing one or more elements selected from the group consisting of cobalt, nickel, lithium, boron, sodium, potassium, and silicon; and the like.

The average thickness of each of the dielectric layers 11 is not particularly limited. From the viewpoint of increasing the number of laminated layers to increase the capacitance while reducing the size of the multilayer ceramic capacitor 100, for example, the average thickness of each of the dielectric layers 11 is preferably 1.0 μm or less, more preferably 0.8 μm or less, and even more preferably 0.5 μm or less. Further, from the viewpoint of increasing productivity and yield, the average thickness of each of the dielectric layers 11 is preferably 0.2 μm or more, and more preferably 0.4 μm or more. The upper limit and the lower limit of the average thickness of each of the dielectric layers 11 can be appropriately combined, and the average thickness of each of the dielectric layers 11 is preferably 0.2 μm or more and 1.0 μm or less, more preferably 0.2 μm or more and 0.8 μm or less, even more preferably 0.4 μm or more and 0.8 μm or less, and yet even more preferably 0.4 μm or more and 0.5 μm or less.

For evaluation of the average thickness of each of the dielectric layers 11, as illustrated in FIG. 1 and FIG. 2, a sample is prepared by polishing or cutting the multilayer ceramic capacitor 100 in the Y-axis direction to its center in the Y-axis direction, thereby exposing an XZ plane in which the dielectric layers 11 and the internal electrodes 12 are laminated. Within the exposed XZ plane, two dielectric layers 11 located at the center in the Z-axis direction are selected, two dielectric layer 11 located at the upper end in the Z-axis direction are selected, and two dielectric layers 11 located at the lower end in the Z-axis direction are selected. At this time, the dielectric layers 11 are selected from within a capacitive part 14.

The thickness of a selected dielectric layer 11 is measured at the center in the X-axis direction, which is the first direction, to determine the thickness of the dielectric layer 11. The thicknesses of all of the selected six dielectric layers 11 are measured by the same procedure, and the average value of the measured thicknesses is calculated. This average value is defined as the average thickness of each of the dielectric layers 11 of the multilayer ceramic capacitor 100. The thicknesses of the dielectric layers 11 can be measured, for example, by a microscope.

### <Internal Electrodes 12>

As illustrated in FIG. 2, a region where the first internal electrodes 12a connected to the metal base layer 20a and the second internal electrodes 12b connected to the metal base layer 20b face each other is a region where capacitance is generated in the multilayer ceramic capacitor 100. Therefore, the region where capacitance is generated is referred to as the capacitive part 14. That is, the capacitive part 14 is a region where the adjacent internal electrodes 12a and 12b connected to the different metal base layers 20a and 20b face each other.

A region where the first internal electrodes 12a connected to the first metal base layer 20a face each other in the lamination direction, without the second internal electrodes 12b connected to the metal base layer 20b interposed therebetween, is referred to as an “end margin 15a”. In addition, a region where the second internal electrodes 12b connected to the metal base layer 20b face each other in the lamination direction, without the first internal electrodes 12a connected to the metal base layer 20a interposed therebetween, is referred to as an “end margin 15b”. The end margin 15a is a region where the internal electrodes 12a connected to the metal base layer 20a face each other in the lamination direction without the internal electrodes 12b connected to the different metal base layer 20b interposed therebetween. The end margin 15b is a region where the internal electrodes 12b connected to the metal base layer 20b face each other in the lamination direction without the internal electrodes 12a connected to the different metal base layer 20a interposed therebetween. The end margins 15a and 15b are regions where capacitance is not generated.

Side margins 16 are regions provided outward of the capacitive part 14 in the second direction that is perpendicular to the lamination direction and perpendicular to the first direction, that is, in a direction along the Y-axis in the example of FIG. 3. In other words, the side margins 16 are regions located adjacent to and outward of the capacitive part 14 when viewed from the lamination direction, that is, regions located adjacent to and outward of the capacitive part 14 on the sides to which the internal electrodes 12 do not extend. The side margins 16 are also regions where capacitance is not generated.

The internal electrodes 12 contain a conductive material. The internal electrodes 12 may further contain a co-existent material as necessary.

The conductive material is not particularly limited, and can be appropriately selected according to the intended purpose. Examples of the conductive material include: base metals such as nickel (Ni), copper (Cu), and tin (Sn), and alloys containing the same; and noble metals such as platinum (Pt), palladium (Pd), silver (Ag), and gold (Au), and alloys containing the same. These may be used alone or in combination. Among them, the internal electrodes 12 preferably contain any of the base metals or an alloy containing any of the base metals as a main component because the manufacturing cost can be reduced even when a large number of the internal electrodes 12 are laminated. More preferably, the internal electrodes 12 contain Ni because the internal electrodes 12 can be fired simultaneously with the dielectric layers 11 and thus has high manufacturing efficiency.

The content of each metal in the internal electrodes 12 can be confirmed by performing elemental analysis of the internal electrodes 12 using various measuring devices, and calculating the atomic ratio of each component relative to all detected elements. Examples of the measuring devices for elemental analysis include: an energy dispersive X-ray spectrometer (EDS) or a wavelength dispersive X-ray spectrometer (WDS) attached to a scanning electron microscope (SEM) or a transmission electron microscope (TEM); an electron probe micro analyzer (EPMA); and a laser ablation-inductively coupled plasma mass spectrometer (LA-ICP-MS).

The co-existent material is not particularly limited, and is, for example, a material that is the same as the ceramic, which is the main component of the dielectric layers 11. The co-existent material preferably contains a compound having a perovskite structure and represented by the general formula ABO_{3-α} (0≤α≤1).

Specific examples of the co-existent material include one or more selected from the group consisting of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr₂O₃ (0≤x≤1, 0≤y≤1, 0≤z≤1) forming a perovskite structure.

Examples of Ba_{1-x-y}CaₓSr_{y}Ti_{1-z}Zr₂O₃ include strontium barium titanate, calcium barium titanate, barium zirconate, barium zirconate titanate, calcium zirconate titanate, calcium barium zirconate titanate, and the like. The compound having the perovskite structure may have an oxygen deficiency regardless of whatever material it is.

The particle size of the co-existent material is not particularly limited, and is preferably smaller than the thickness of each of the internal electrodes 12. From the viewpoint of reducing the thicknesses of the internal electrodes 12, the particle size of the co-existent material is preferably 10 nm or more and 100 nm or less, and more preferably 10 nm or more and 50 nm or less.

The content of the co-existent material in the internal electrodes 12 is not particularly limited, and can be appropriately selected according to the intended purpose.

The content of the co-existent material in the internal electrodes 12 is the ratio by mass of the co-existent material when the content of the conductive material in the internal electrodes 12 is 100% by mass. The content of the co-existent material in the internal electrodes 12 can be calculated from the amounts of raw materials charged when the internal electrodes 12 are produced.

The average thickness of each of the internal electrodes 12 is not particularly limited. From the viewpoint of increasing the number of laminated layers to increase the capacitance while reducing the size of the multilayer ceramic capacitor 100, for example, the average thickness of each of the internal electrodes 12 is preferably 1.0 μm or less, more preferably 0.8 μm or less, and even more preferably 0.6 μm or less. Further, from the viewpoint of increasing productivity and yield, the average thickness of each of the internal electrodes 12 is preferably 0.2 μm or more, more preferably 0.3 μm or more, and even more preferably 0.4 or more. The upper limit and the lower limit of the average thickness of each of the internal electrodes 12 can be appropriately combined, and the average thickness of each of the internal electrodes 12 is preferably 0.2 μm or more and 0.8 μm or less, more preferably 0.2 μm or more and 0.6 μm or less, even more preferably 0.3 μm or more and 0.6 μm or less, and yet even more preferably 0.4 μm or more and 0.6 μm or less.

For evaluation of the average thickness of each of the internal electrodes 12, as illustrated in FIG. 1 and FIG. 2, a sample is prepared by polishing or cutting the multilayer ceramic capacitor 100 in the Y-axis direction to its center in the Y-axis direction, thereby exposing an XZ plane in which the dielectric layers 11 and the internal electrodes 12 are laminated. Within the exposed XZ plane, two internal electrodes 12 located at the center in the Z-axis direction are selected, two internal electrodes 12 located at the upper end in the Z-axis direction are selected, and two internal electrodes 12 located at the lower end in the Z-axis direction are selected. At this time, the internal electrodes 12 are selected from within the capacitive part 14.

The thickness of a selected dielectric layer 12 is measured at the center in the X-axis direction, which is the first direction, to determine the thickness of the internal electrode 12. The thicknesses of all of the selected six internal electrodes 12 are measured by the same procedure, and the average value of the measured thicknesses is calculated. This average value is defined as the average thickness of each of the internal electrodes 12 of the multilayer ceramic capacitor 100. The thicknesses of the internal electrodes 12 can be measured, for example, by a microscope.

<Metal Base Layers 20a and 20b>

Each of the metal base layers 20a and 20b is disposed so as to extend from a corresponding one of the end surfaces 10a and 10b, which are the pair of end surfaces of the element body 10 facing in the first direction, to a portion of the four surfaces 10c, 10d, 10e, and 10f. More specifically, the metal base layer 20a is disposed so as to extend from one end surface 10a of the element body 10 to a portion of at least one surface of the four surfaces 10c, 10d, 10e, and 10f. The metal base layer 20b is disposed so as to extend from the other end surface 10b of the element body 10 to a portion of the four surfaces 10c, 10d, 10e, and 10f.

The metal base layers 20a and 20b include: the first metal layers 21a and 21b disposed on portions of at least one surface of the four surfaces 10c, 10d, 10e, and 10f of the element body 10; and the second metal layers 22a and 22b continuously covering the end surfaces 10a and 10b of the element body 10 and portions on the end surface 10a side and the end surface 10b side of the first metal layers 21a and 21b, and electrically connected to the internal electrodes 12. The plating layers 23a and 23b continuously cover the first metal layers 21a and 21b and the second metal layers 22a and 22b.

On a surface on which the first metal layers 21a and 21b are disposed, a step is formed between each of the upper surfaces of the first metal layers 21a and 21b (the surfaces opposite to the surfaces in contact with the element body 10) and each of the upper surfaces of the second metal layers 22a and 22b (the surfaces opposite to the surfaces in contact with the first metal layers 21a and 21b) in a cross-sectional view of the Z-X plane. As a result, a step T1 is formed between each of the plating layers 23a and 23b disposed so as to conform to the upper surfaces of the first metal layers 21a and 21b and each of the plating layers 23a and 23b disposed so as to conform to the upper surfaces of the second metal layers 22a and 22b. Therefore, in a plan view of the plating layers 23a and 23b, the surface on which the first metal layers 21a and 21b are disposed can be distinguished. From the viewpoint of more convenient distinction, it is preferable to provide a visual distinction such as a marker, such that the surface on which the first metal layers 21a and 21b are disposed can be distinguished from a surface on which the first metal layers 21a and 21b are not disposed.

The step T1 is not particularly limited, and is preferably 1 μm or more and 10 μm or less, and more preferably 1 μm or more and 5 μm or less. The step T1 can be measured, for example, by a microscope.

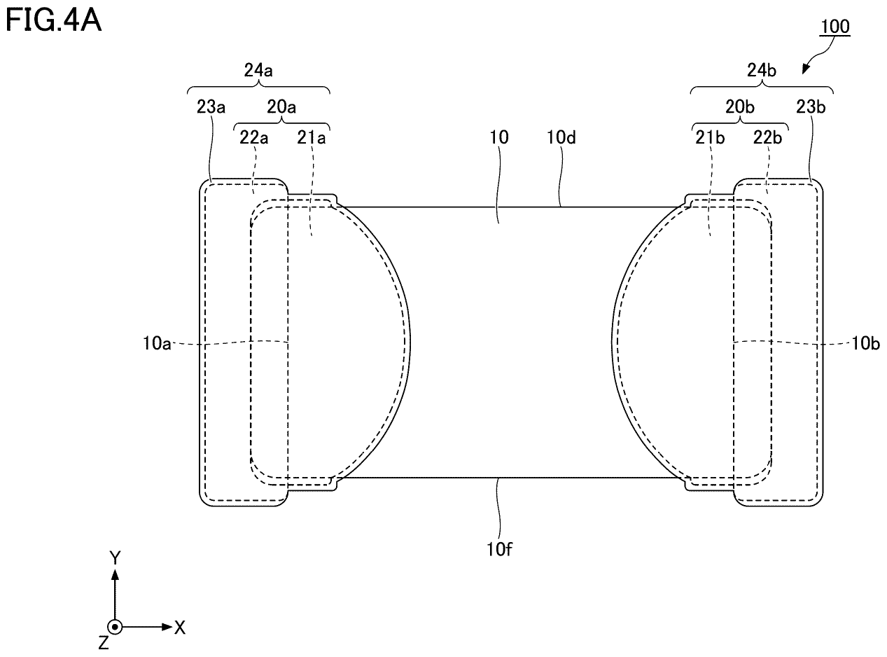

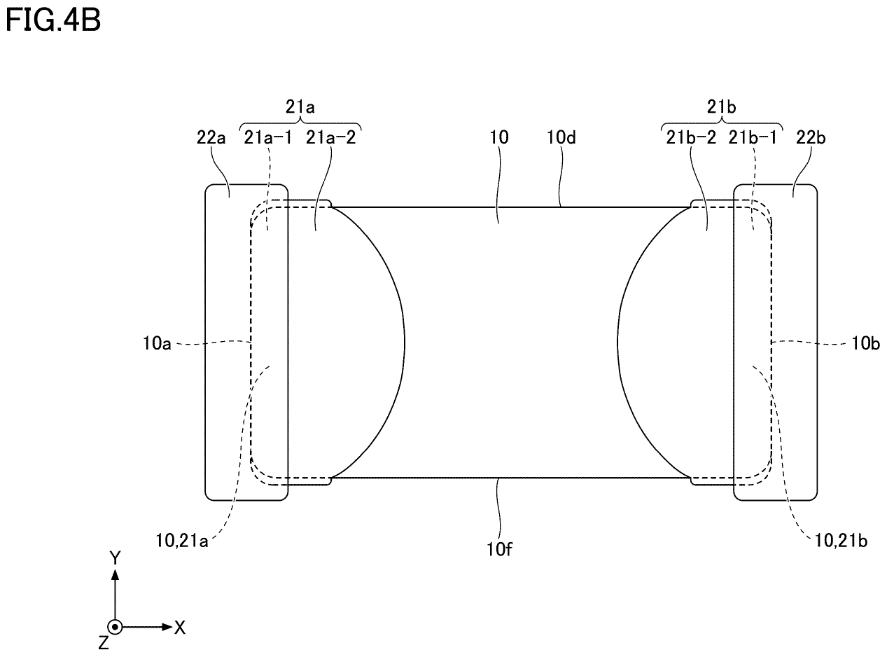

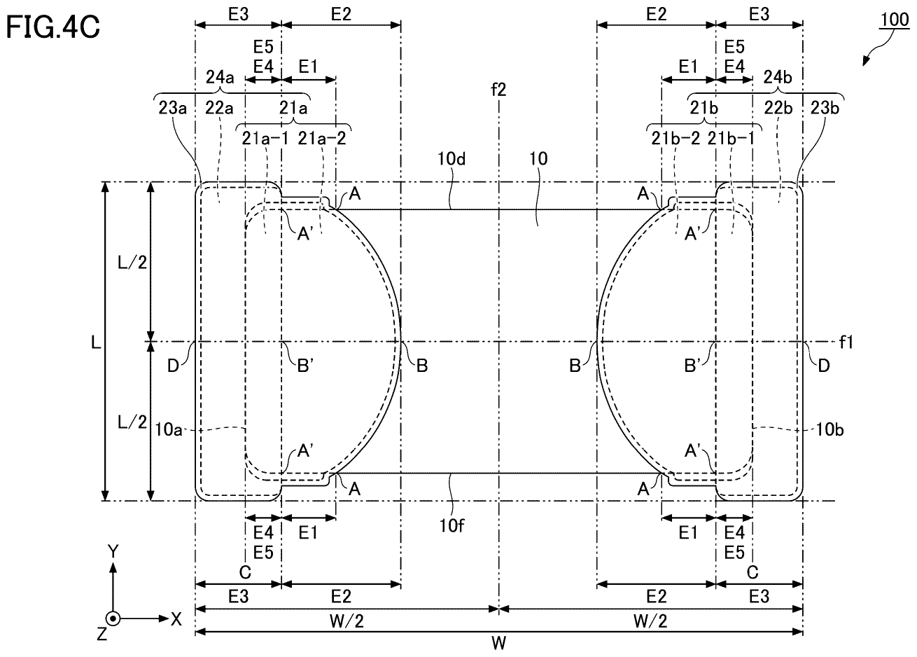

FIG. 4A is a plan view illustrating an example of the multilayer ceramic capacitor according to the first embodiment. FIG. 4B is a schematic explanatory view illustrating the relationship between the first metal layers and the second metal layers, in which the plating layers illustrated in FIG. 4A are omitted. FIG. 4C is a schematic explanatory view illustrating the size of each part illustrated in FIG. 4A. As described above, the metal base layers 20a and 20b illustrated in FIG. 4A to FIG. 4C have a configuration in which the metal base layers 20a and 20b are disposed on at least one surface of the four surfaces 10c, 10d, 10e, and 10f of the element body 10. However, it is assumed that the metal base layers 20a and 20b on the four surfaces 10c, 10d, 10e, and 10f of the element body 10 have the same configuration. That is, although the plan view of FIG. 4A illustrates a surface of the multilayer ceramic capacitor 100 to be mounted on a circuit board, that is, the surface 10f, but the other three surfaces 10c, 10d, and 10e have the same plan view.

In a plan view of at least one surface having the first metal layers 21a and 21b, the first metal layer 21a has a first region 21a-1 covered by the second metal layer 22a and a second region 21a-2 not covered by the second metal layer 22a. Similarly, in a plan view of at least one surface having the first metal layers 21a and 21b, the first metal layer 21b has a first region 21b-1 covered by the second metal layer 22b and a second region 21b-2 not covered by the second metal layer 22b.

The expression “the first metal layers 21a and 21b are covered by the second metal layers 22a and 22b in the first regions 21a-1 and 21b-1” means that the first metal layers 21a and 21b are disposed on at least one surface of the four surfaces 10c, 10d, 10e, and 10f of the element body 10, and the second metal layers 22a and 22b are further disposed on the upper surfaces of the first metal layers 21a and 21b.

In a plan view of at least one surface of the element body 10 having the first metal layers 21a and 21b, portions of the outer peripheries of the second regions 21a-2 and 21b-2 have curved shapes projecting from the first region 21a-1 side and the first region 21b-1 side toward the center portion of the element body 10. Further, portions of the outer peripheries of the second regions 21a-2 and 21b-2 preferably have smooth curved shapes projecting outward.

Further, in a plan view of at least one surface having the first metal layers 21a and 21b, outer edges of the plating layers 23a and 23b have curved shapes projecting from the end surface 10a side and the end surface 10b side toward the center portion of the element body 10. Because the outermost layers are the plating layers 23a and 23b, the first metal layers 21a and 21b and the second metal layers 22a and 22b cannot be visually recognized from the appearance of the multilayer ceramic capacitor 100 in a plan view. Therefore, the “plan view” in the present disclosure includes a plan view (for example, FIG. 4B) illustrating a state before the plating layers 23a and 23b are formed in a manufacturing process of the multilayer ceramic capacitor 100.

In a plan view of at least one surface of the element body 10 having the first metal layers 21a and 21b, the outer edges of the plating layers 23a and 23b have curved shapes projecting from the end surface 10a side and the end surface 10b side toward the center portion of the element body 10. Further, in a plan view of at least one surface of the element body 10 having the first metal layers 21a and 21b, an intersection point between each of the outer edges of the element body 10, facing in the second direction perpendicular to the first direction, and an outer edge of a corresponding one of the plating layers 23a and 23b is defined as an intersection point A, an intersection point between each of the outer edges of the element body 10, facing in the second direction, and a boundary between a corresponding one of the first regions 21a-1 and 21b-1 and a corresponding one of the second regions 21a-2 and 21b-2 is defined as an intersection point A′, an imaginary straight line parallel to the first direction and passing through a midpoint, in the second direction, of the corresponding one of the plating layers 23a and 23b at a position where the corresponding one of the plating layers 23a and 23b has a maximum length L in the second direction is defined as an imaginary straight line f1, an outermost point of the corresponding one of the plating layers 23a and 23b on the imaginary straight line f1 on the element body 10 is defined as an outermost point B, and an intersection point between the imaginary straight line f1 and the boundary between the corresponding one of the first regions 21a-1 and 21b-1 and the corresponding one of the second regions 21a-2 and 21b-2 is defined as an intersection point B′. In this case, a linear distance E1 from the intersection point A to the intersection point A′ in the first direction and a linear distance E2 from the outermost point B to the intersection point B′ in the first direction satisfy Equation 1 below.

$$E 1 \neq E 2 \qquad Equation l$$

In Equation 1 above, E1>0 and E2>0.

In the range of the linear distance E1, there are a region where the corresponding one of the plating layers 23a and 23b is laminated on the corresponding one of the first metal layers 21a and 21b within the corresponding one of the second regions 21a-2 and 21b-2 on at least one surface of the element body 10 having the first metal layers 21a and 21b, and a region where the corresponding one of the plating layers 23a and 23b is provided on the at least one surface of the element body 10 having the first metal layers 21a and 21b. In the range of the linear distance E1, the greater the length occupied by the region where the corresponding one of the plating layers 23a and 23b is laminated on the corresponding one of the first metal layers 21a and 21b within the corresponding one of the second regions 21a-2 and 21b-2, the more suitably the ridge portions of the four surfaces 10c, 10d, 10e, and 10f of the element body 10 can be protected.

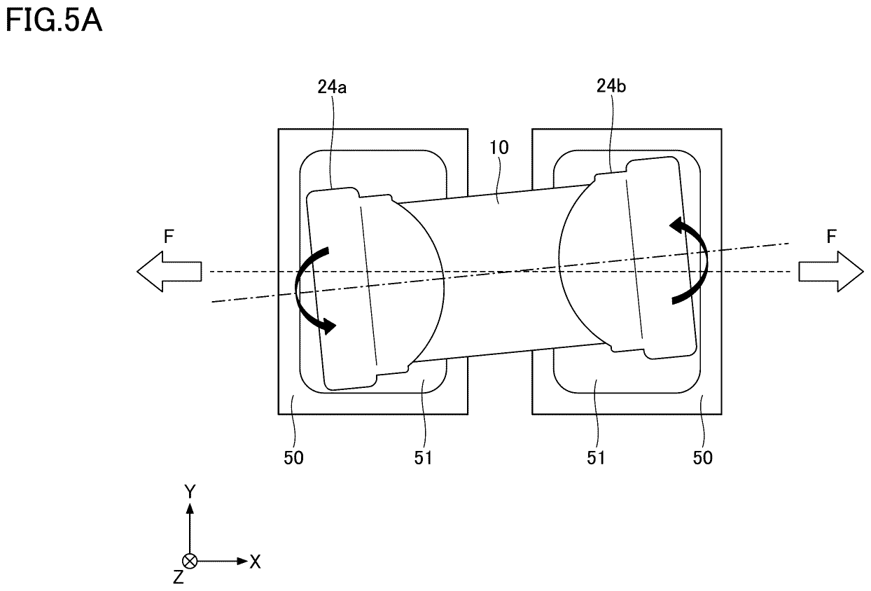

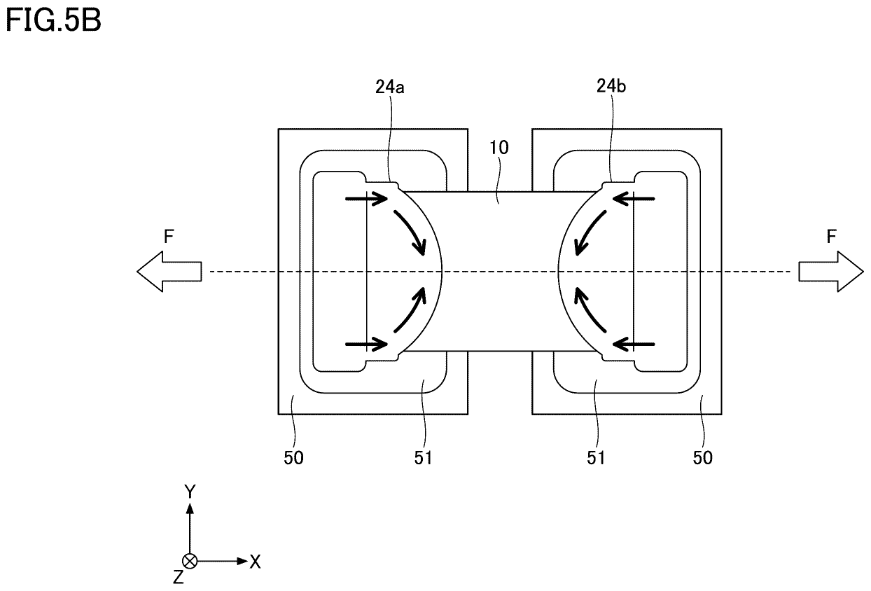

FIG. 5A and FIG. 5B are schematic top views when the multilayer ceramic capacitor according to the first embodiment is mounted by being fixed to a land part of a wiring pattern with solder. When the multilayer ceramic capacitor 100 according to the first embodiment is fixed to a land part 50 with solder 51, tension F (indicated by white arrows) is applied to the external electrodes 24a and 24b in the X-axis direction by the surface tension of the molten solder 51. Thus, a rotational moment (indicated by black arrows in FIG. 5A) is applied to the external electrodes 24a and 24b.

However, in the multilayer ceramic capacitor 100 according to the first embodiment, by satisfying Equation 1 above, the tension of the solder is concentrated at the steps T1 illustrated in FIG. 2 from the plating layers 23a and 23b located on the second metal layers 22a and 22b toward the plating layers 23a and 23b located on the first metal layers 21a and 21b, and also the tension of the solder is concentrated toward the apex of the curved outer edge defining each of the plating layers 23a and 23b, that is, toward the outermost point B of each of the plating layers 23a and 23b on the imaginary straight line f1 (as indicated by black arrows in FIG. 5B). As a result, the tension F can be canceled, positional displacement of the multilayer ceramic capacitor 100 can be suppressed, and the multilayer ceramic capacitor 100 can be disposed at a predetermined position of the land part 50 with a desired mounting orientation. Such a movement in which the multilayer ceramic capacitor 100 is naturally positioned while the solder 51 melts and solidifies is referred to as a “self-alignment effect”.

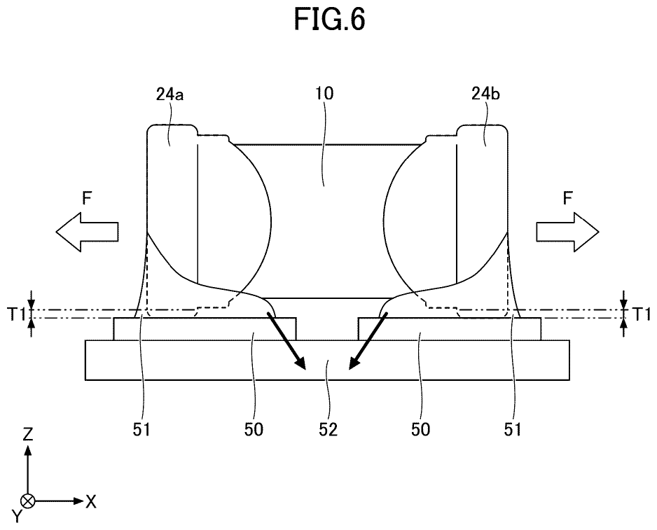

Next, FIG. 6 is a schematic side view when the multilayer ceramic capacitor according to the first embodiment is mounted by being fixed to the land part of the wiring pattern with the solder. When the multilayer ceramic capacitor 100 is fixed to the land part 50 on a substrate body 52 with the solder 51, the tension F (indicated by white arrows) is applied to the external electrodes 24a and 24b in the X-axis direction by the surface tension of the molten solder 51.

However, the multilayer ceramic capacitor 100 according to the first embodiment includes the steps T1 between the plating layer 23a within the first region 21a-1 and the plating layer 23a within the second region 21a-2 and between the plating layer 23b within the first region 21b-1 and the plating layer 23b within the second region 21b-2 at the surfaces of the external electrodes 24a and 24b. Thus, gaps are formed between the land part 50 and the plating layers 23a and 23b within the second regions 21a-2 and 21b-2, and the solder 51 can enter the gaps. Therefore, the tension of the solder 51 is concentrated toward the land part 50 and the substrate body 52 (indicated by black arrows). Further, in the gaps between the land part 50 and the plating layers 23 within the second regions 21a-2 and 21b-2, as described with reference to FIG. 5B, the tension of the solder 51 is concentrated toward the apex of the curved outer edge defining each of the plating layers 23a and 23b, that is, toward the outermost point B of each of the plating layers 23a and 23b on the imaginary straight line f1. Thus, the solder 51 tends to gather near the center portion of the element body 10. Therefore, a large amount of the solder 51 enters the gaps between the land part 50 and the plating layers 23 within the second regions 21a-2 and 21b-2 in the vicinity of the center portion of the element body 10. As a result, the tension F can be canceled, and the tombstone phenomenon can be suppressed by the self-alignment effect. Accordingly, the multilayer ceramic capacitor 100 can be disposed at a predetermined position of the land part 50 with a desired orientation.

Further, because the solder 51 enters the gaps between the land part 50 and the plating layers 23a and 23b within the second regions 21a-2 and 21b-2, the multilayer ceramic capacitor 100 according to the first embodiment can suppress wicking of excess solder 51 along the surfaces on the end surface 10a side and the end surface 10b side of the plating layers 23a and 23b, and can suppress damage to the multilayer ceramic capacitor 100 due to deflection of the substrate body 52.

From the viewpoint of suppressing positional displacement of the multilayer ceramic capacitor 100, preferably, the linear distance E1 and the linear distance E2 further satisfy Equation 2 below.

$$E 1 < E 2 \qquad Equation 2$$

In Equation 2 above, E1>0 and E2>0.

The linear distance E1 is not particularly limited as long as E1>0. The linear distance E1 can be appropriately adjusted according to the size of the multilayer ceramic capacitor 100, and is preferably in a range of 50 μm to and 250 μm, and more preferably in a range of 100 μm to 500 μm. For example, the linear distance E1 can be measured as follows. A sample is prepared by polishing or cutting the multilayer ceramic capacitor so as to expose the element body 10 in a plane perpendicular to a surface of the element body 10 having the first metal layers 21a and 21b. Then, in the exposed cross-section, the length from the intersection point A to the intersection point A′ can be measured by, for example, a microscope.

The linear distance E2 is not particularly limited as long as Equation 1 is satisfied and E2>0. The linear distance E2 can be appropriately adjusted according to the size of the multilayer ceramic capacitor 100, and is preferably in a range of 100 μm to 300 μm, and more preferably in a range of 200 μm to 700 μm. For example, the linear distance E2 can be measured as follows. A sample is prepared by polishing or cutting the multilayer ceramic capacitor to a center portion of the element body 10, that is, to the imaginary straight line f1 in a plane perpendicular to a surface of the element body 10 having the first metal layers 21. Then, in the exposed cross-section, the length from the outermost point B of the corresponding one of the plating layers 23a and 23b on the imaginary straight line f1 to the intersection point B′ can be measured by, for example, a microscope.

When an outermost point on the end surface 10a side or the end surface 10b side of the corresponding one of the plating layers 23a and 23b on the imaginary straight line f1 is defined as an outermost point D, a linear distance E3 from the intersection point B′ to the outermost point D and the linear distance E2 preferably satisfy Equation 3 below in a plan view of at least one surface of the element body 10 having the first metal layers 21a and 21b. Accordingly, wicking of excess solder 51 can be suppressed.

$$E 3 < E 2 \qquad Equation 3$$

In Equation 3 above, E3>0 and E2>0.

The linear distance E3 is not particularly limited as long as Equation 3 is satisfied and E3>0. The linear distance E3 can be appropriately adjusted according to the size of the multilayer ceramic capacitor 100, and is preferably in a range of 50 μm to 250 μm, and more preferably in a range of 50 μm to 150 μm. When the linear distance E3 is 50 μm or more, damage to the corner portions of the element body 10, which are susceptible to external shocks, can be prevented in the multilayer ceramic capacitor 100. Further, when the linear distance E3 is 250 μm or less, the linear distance E2 can be increased, which is preferable because the tombstone phenomenon can be suppressed by the self-alignment effect and also wicking of excess solder 51 can be suppressed. For example, the linear distance E3 can be measured as follows. A sample is prepared by polishing or cutting the multilayer ceramic capacitor to a center portion of the element body 10, that is, to the imaginary straight line f1 in a plane perpendicular to a surface of the element body 10 having the first metal layers 21a and 21b. Then, in the exposed cross-section, the length from the intersection point B′ to the outermost point D can be measured by, for example, a microscope.

The linear distance E1, the linear distance E2, and the linear distance E3 can be adjusted according to the thicknesses of the plating layers 23a and 23b. Alternatively, the average thickness of each of the plating layers 23a and 23b is made constant in any region, and the linear distances may be adjusted according to the sizes of the first metal layers 21a and 21b and the second metal layers 22a and 22b. Similarly, the steps T1 can be adjusted according to the thicknesses of the plating layers 23a and 23b. Alternatively, the average thickness of each of the plating layers 23a and 23b is made constant in any region, and the steps T1 may be adjusted according to the thicknesses of the first metal layers 21a and 21b and the second metal layers 22a and 22b.

Further, when an intersection line with respect to each of the end surfaces 10a and 10b of the element body 10 is defined as an intersection line C, a linear distance E4 from the intersection point A′ to the intersection line Cis preferably E4>0. The fact that E4>0 means that the metal base layers 20a and 20b have the first regions 21a-1 and 21b-1 at the corner portions of the element body 10. When E4>0, damage to the corner portions of the element body 10, which are susceptible to external shocks, can be prevented in the multilayer ceramic capacitor 100. For example, the linear distance E4 can be measured as follows. A sample is prepared by polishing or cutting the multilayer ceramic capacitor to the outer edge of the element body 10 in a plane perpendicular to a surface of the element body 10 having the first metal layers 21a and 21b. Then, in the exposed cross-section, the length from the intersection point A′ to the intersection line C can be measured by, for example, a microscope.

Further, a linear distance E5 from the intersection point B′ to the intersection line C on the imaginary straight line f1 is preferably greater than 0 (E5>0). The fact that E5>0 means that the metal base layers 20a and 20b have the first regions 21a-1 and 21b-1 on the imaginary straight line f1. When E5>0, the steps T1 are located on the imaginary straight line f1. For example, the linear distance E5 can be measured as follows. A sample is prepared by polishing or cutting the multilayer ceramic capacitor to a center portion of the element body 10 in a plane perpendicular to a surface of the element body 10 having the first metal layers 21a and 21b. Then, in the exposed cross-section, the length from the intersection point B′ to the intersection line C can be measured by, for example, a microscope.

In a plan view of at least one surface of the element body 10 having the first metal layers 21a and 21b, each of the shapes of the metal base layers 20a and 20b is preferably line-symmetric with respect to the imaginary straight line f1 serving as an axis of symmetry.

Further, in a plan view of at least one surface of the element body 10 having the first metal layers 21a and 21b, from the viewpoint of an alignment effect, each of the shapes of the first metal layers 21a and 21b and the shapes of the second metal layers 22a and 22b is preferably line-symmetric with respect to the imaginary straight line f1 serving as the axis of symmetry.

In the present disclosure, the expression that the shape of a certain member and the shape of another certain member are “line-symmetric” includes not only a case where the target members completely coincide with each other when the target members are brought together with respect to the axis of symmetry, but also an error within a range that allows effects of the present disclosure to be obtained. Preferably, in a case where one outer edge of one of the target members is taken as a reference, an error of +5 μm with respect to the reference outer edge can be included. Further, an outer edge defining each member is preferably formed as a flat surface. However, the flat surface is not required to be strictly flat as long as it is recognized as flat when viewed as a whole, and includes, for example, a surface having a minute uneven shape, a surface having a gently curved shape in a predetermined range, and the like. Therefore, the expression that the shape of a certain member and the shape of another certain member are “line-symmetric” does not mean that such minute uneven shapes completely coincide with each other when the target members are brought together with respect to the axis of symmetry.

<<First Metal Layers 21a and 21b and Second Metal Layers 22a and 22b>>

The composition of the first metal layers 21a and 21b and the composition of the second metal layers 22a and 22b are not particularly limited, and can be appropriately selected according to the intended purpose from components that are typically used for the external electrodes of the multilayer ceramic capacitor 100. The composition of the first metal layers 21a and 21b and the composition of the second metal layers 22a and 22b may be the same or different. When the composition of the first metal layers 21a and 21b and the composition of the second metal layers 22a and 22b are different, different functions can be imparted to the first metal layers 21a and 21b and the second metal layers 22a and 22b.

For example, when the first metal layers 21a and 21b are provided for the purpose of improving electrical connection between the internal electrodes 12 and the metal base layers 20a and 20b, and the second metal layers 22a and 22b are provided for the purpose of improving resistance to a plating process, the first metal layers 21a and 21b preferably contain a metal that is the same as that contained in the internal electrodes 12 (for example, a base metal such as nickel (Ni), copper (Cu), or tin (Sn), or an alloy containing the same; or a precious metal such as platinum (Pt), palladium (Pd), silver (Ag), gold (Au), or an alloy containing the same), and the second metal layers 22a and 22b preferably contain a metal containing a glass component containing Si as a main component. For example, when the inner electrodes 12 contain Ni as a main component, the first metal layers 21a and 21b can contain Ni as a main component, and the second metal layers 22a and 22b can contain Ni containing glass containing Si as a main component, Cu containing glass containing Si as a main component, or the like.

Further, for example, when the first metal layers 21a and 21b are provided for the purpose of improving adhesion strength between the element body 10 and the metal base layers 20a and 20b, and the second metal layers 22a and 22b are provided for the purpose of improving plating, the first metal layers 21a and 21b preferably contain a metal containing a glass component containing Si as a main component, and the second metal layers 22a and 22b preferably contain a metal containing a glass component containing at least one of Ba or B as a main component. As an example, the first metal layers 21a and 21b can contain Ni containing glass containing Si as a main component, Cu containing glass containing Si as a main component, or the like, and the second metal layers 22a and 22b can contain Ni containing glass containing Ba as a main component, Cu containing glass containing Ba as a main component, Ni containing glass containing B as a main component, Cu containing glass containing B as a main component, or the like.

Further, the first metal layers 21a and 21b and the second metal layers 22a and 22b may contain a co-existent material in the form of ceramic particles. The co-existent material in the first metal layers 21a and 21b and the second metal layers 22a and 22b may be the same as the co-existent material in the internal electrodes 12, and preferably contains a compound having a perovskite structure and represented by the general formula ABO_{3-α} (0≤α≤1).

The content of each metal and the content of a component other than the metal in the first metal layers 21a and 21b and the second metal layers 22a and 22b can be confirmed by performing elemental analysis of the first metal layers 21a and 21b and the second metal layers 22a and 22b using various measuring devices, and calculating the atomic ratio of each component relative to all detected elements. Examples of the measuring devices for elemental analysis include those described for the measurement of the content of each metal in the internal electrodes 12.

The average thickness of each of the first metal layers 21a and 21b is not particularly limited, and is preferably in a range of 10 μm to 100 μm, more preferably in a range of 15 μm to 75 μm, and even more preferably in a range of 25 μm to 50 μm from the viewpoint of resistance to external shocks and suppression of moisture ingress.

The average thickness of each of the second metal layers 22a and 22b disposed on at least one surface of the element body 10 having the first metal layers 21a and 21b is not particularly limited, and is preferably in a range of 10 μm to 100 μm, more preferably in a range of 15 μm to 75 μm, and even more preferably in a range of 25 μm to 50 μm from the viewpoint of resistance to external shocks and suppression of moisture ingress.

Further, the average thickness of each of the second metal layers 22a and 22b disposed on the end surfaces 10a and 10b of the element body 10 is not particularly limited, and is preferably in a range of 25 μm to 200 μm, more preferably in a range of 50 μm to 150 μm, and even more preferably in a range of 75 μm to 100 μm from the viewpoint of resistance to external shocks and suppression of moisture ingress.

For evaluation of the average thickness of each of the first metal layers 21a and 21b and the average thickness of each of the second metal layers 22a and 22b disposed at least one surface of the element body 10 having the first metal layers 21a and 21b, as illustrated in FIG. 1 and FIG. 2, a sample is prepared by polishing or cutting the multilayer ceramic capacitor 100 in the Y-axis direction to its center in the Y-axis direction, thereby exposing a surface having the first metal layers 21a and 21b and the second metal layers 22a and 22b. In the exposed cross section, three points equally spaced along the X-axis are selected for each of the first metal layers 21a and 21b and the second metal layers 22a and 22b to be measured, and thicknesses are measured at these points. Then, the average values of the measured thicknesses are calculated. The average values are defined as the average thickness of each of the first metal layers 21a and 21b and the average thickness of each of the second metal layers 22a and 22b in the multilayer ceramic capacitor 100, respectively. The thicknesses of the first metal layers 21a and 21b and the second metal layers 22a and 22b can be measured, for example, by a microscope.

Further, For evaluation of the average thickness of each of the second metal layers 22a and 22b disposed on the end surfaces 10a and 10b of the element body 10, similar to the above, as illustrated in FIG. 1 and FIG. 2, a sample is prepared by polishing or cutting the multilayer ceramic capacitor 100 in the Y-axis direction to its center in the Y-axis direction, thereby exposing a surface having the first metal layers 21a and 21b and the second metal layers 22a and 22b. In the exposed cross section, three points equally spaced along the Z-axis are selected for each of the second metal layers 22a and 22b to be measured, which are disposed on the end surfaces 10a and 10b of the element body 10, and thicknesses are measured at these points. Then, the average value of the measured thicknesses is calculated. This average value is defined as the average thickness of each of the second metal layers 22a and 22b disposed on the end surfaces 10a and 10b of the element body 10 in the multilayer ceramic capacitor 100.

<<Plating Layers 23a and 23b>>

The composition of the plating layers 23a and 23b is not particularly limited, and can be appropriately selected according to the intended purpose. From the viewpoint of improving the reliability and solderability of the multilayer ceramic capacitor 100, the composition of the plating layers 23a and 23b preferably includes a metal such as copper (Cu), nickel (Ni), or tin (Sn), or an alloy thereof. Each of the plating layers 23a and 23b may be composed of a plurality of layers formed of any of these metals.

The average thickness of each of the plating layers 23a and 23b is not particularly limited, and is preferably in a range of 1 μm to 20 μm, more preferably in a range of 3 μm to 15 μm, and even more preferably in a range of 5 μm to 10 μm. The plating layers 23a and 23b disposed on the first metal layers 21a and 21b and the second metal layers 22a and 22b and the plating layers 23a and 23b disposed on the end surfaces 10a and 10b of the element body 10 may have the same average thickness or different average thicknesses, and preferably have the same average thickness from the viewpoint of improving manufacturing efficiency.

The multilayer ceramic capacitor 100 according to the first embodiment can be appropriately manufactured by a method of manufacturing a multilayer ceramic electronic component according to an embodiment of the present disclosure described later.

### Second Embodiment

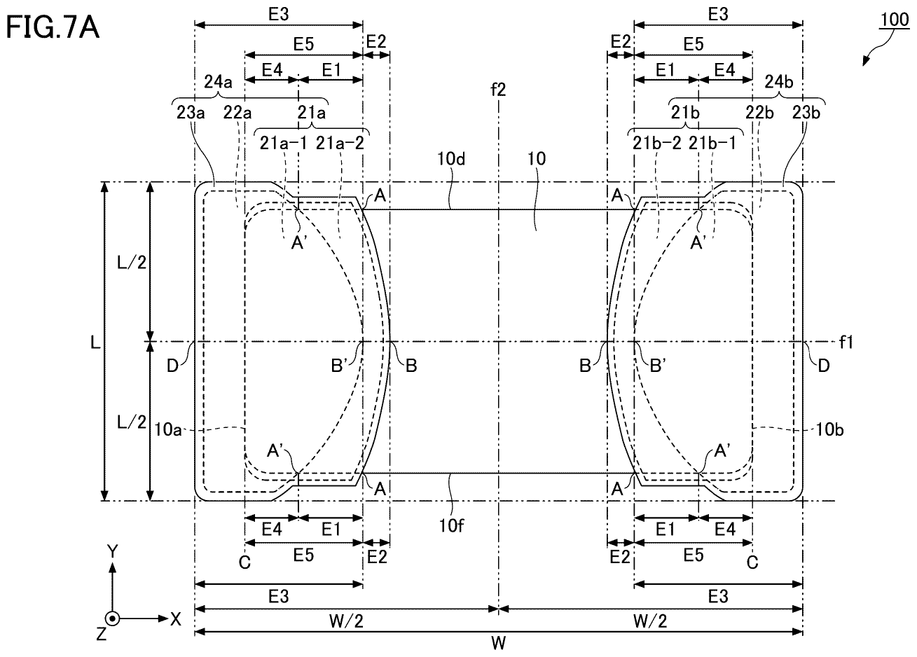

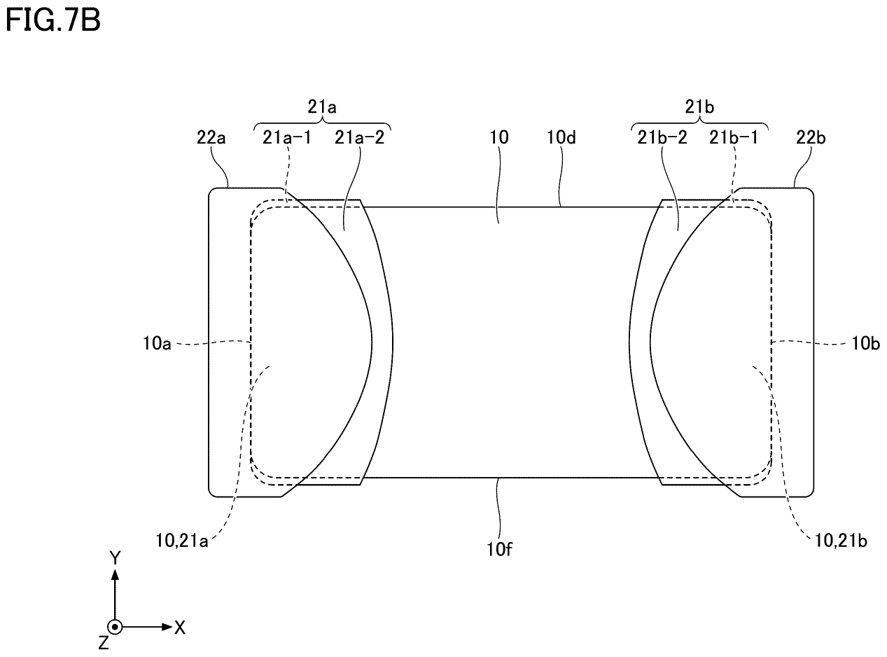

FIG. 7A is a plan view illustrating an example of a multilayer ceramic capacitor according to a second embodiment. FIG. 7B is a schematic explanatory view illustrating the relationship between the first metal layers and the second metal layers, in which the plating layers illustrated in FIG. 7A are omitted.

A multilayer ceramic capacitor 100 according to the second embodiment is the same as the multilayer ceramic capacitor 100 according to the first embodiment, except that the shapes of the metal base layers 20a and 20b are changed to those illustrated in FIG. 7A and FIG. 7B. Hereinafter, the differences of the multilayer ceramic capacitor 100 according to the second embodiment from the multilayer ceramic capacitor 100 according to the first embodiment will be described.

In the multilayer ceramic capacitor 100 according to the second embodiment, the linear distance E1 and the linear distance E2 do not satisfy Equation 2, and satisfy Equation 4 below. That is, the relationship between the linear distance E1 and the linear distance E2 in the multilayer ceramic capacitor 100 according to the second embodiment is opposite to that in the multilayer ceramic capacitor 100 according to the first embodiment.

$$E 1 > E 2 \qquad Equation 4$$

In Equation 4 above, E1>0 and E2>0.

In the multilayer ceramic capacitor 100 according to the second embodiment satisfying Equation 4, similar to the multilayer ceramic capacitor 100 according to the first embodiment, the tension of solder is concentrated at the steps T1 from the plating layers 23a and 23b disposed on the second metal layers 22a and 22b toward the plating layers 23a and 23b disposed on the first metal layers 21a and 21b, and also the tension of the solder is concentrated toward the apex of the curved outer edge defining each of the plating layers 23a and 23b, that is, toward the outermost point B of each of the plating layers 23a and 23b on the imaginary straight line f1. As a result, positional displacement of the multilayer ceramic capacitor 100 can be suppressed, and the multilayer ceramic capacitor 100 can be disposed at a predetermined position of a land part 50 with a desired mounting orientation. Further, similar to the multilayer ceramic capacitor 100 according to the first embodiment, the multilayer ceramic capacitor 100 according to the second embodiment can suppress the tombstone phenomenon by the self-alignment effect.

Further, in the multilayer ceramic capacitor 100 according to the second embodiment, the linear distance E3 and the linear distance E2 do not satisfy Equation 3, and satisfy Equation 5 below. That is, the relationship between the linear distance E3 and the linear distance E2 of the multilayer ceramic capacitor 100 according to the second embodiment is also opposite to that in the multilayer ceramic capacitor 100 according to the first embodiment. The multilayer ceramic capacitor 100 according to the first embodiment is superior in suppressing wicking of excess solder 51; however, in the second embodiment, the tension is more concentrated toward the outermost point B of each of the plating layers 23a and 23b on the imaginary straight line f1, and thus positional displacement by the self-alignment effect is more reliably suppressed.

$$E 3 > E 2 \qquad Euation 5$$

In Equation 5 above, E3>0 and E2>0.

### Third Embodiment

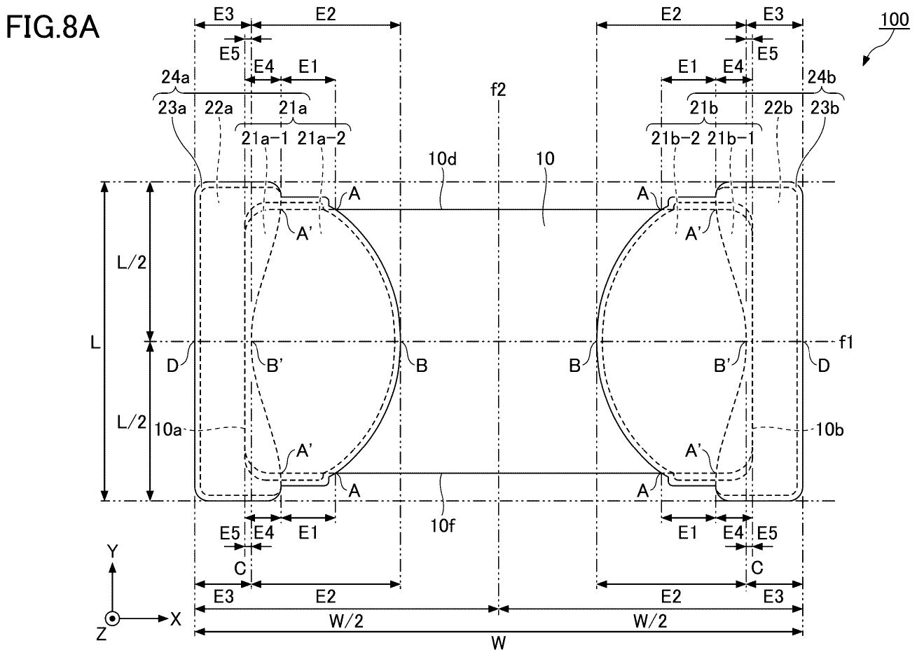

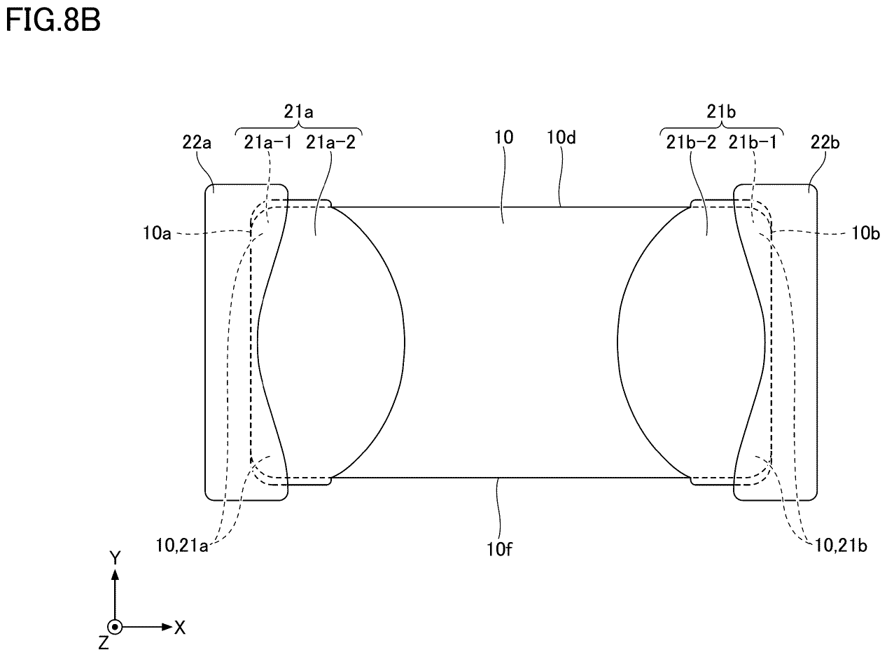

FIG. 8A is a plan view illustrating an example of a multilayer ceramic capacitor according to a third embodiment. FIG. 8B is a schematic explanatory view illustrating the relationship between the first metal layers and the second metal layers, in which the plating layers illustrated in FIG. 8A are omitted.

A multilayer ceramic capacitor 100 according to the third embodiment is the same as the multilayer ceramic capacitor 100 according to the first embodiment, except that the shapes of the metal base layers 20a and 20b are changed to those illustrated in FIG. 8A and FIG. 8B. Hereinafter, the differences of the multilayer ceramic capacitor 100 according to the third embodiment from the multilayer ceramic capacitor 100 according to the first embodiment will be described.

In the multilayer ceramic capacitor 100 according to the third embodiment, the intersection point B′ on the imaginary straight line f1 is very close to each of the end surfaces 10a and 10b of the element body 10. That is, the linear distance E5 is smaller than that in the multilayer ceramic capacitor 100 according to the first embodiment. Thus, the linear distance E2 is greater, and wicking of solder 51 can be further suppressed.

### Fourth Embodiment

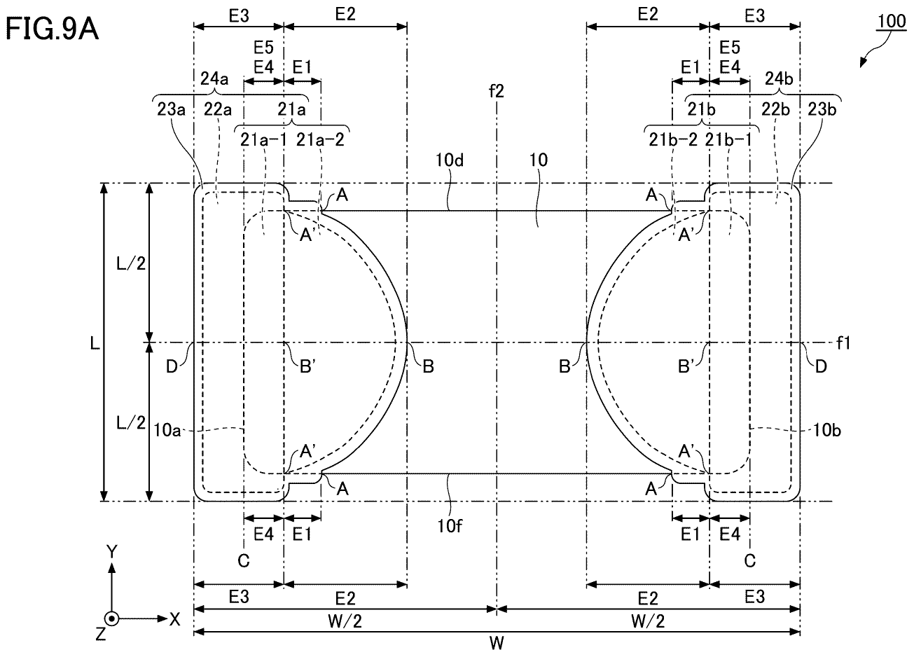

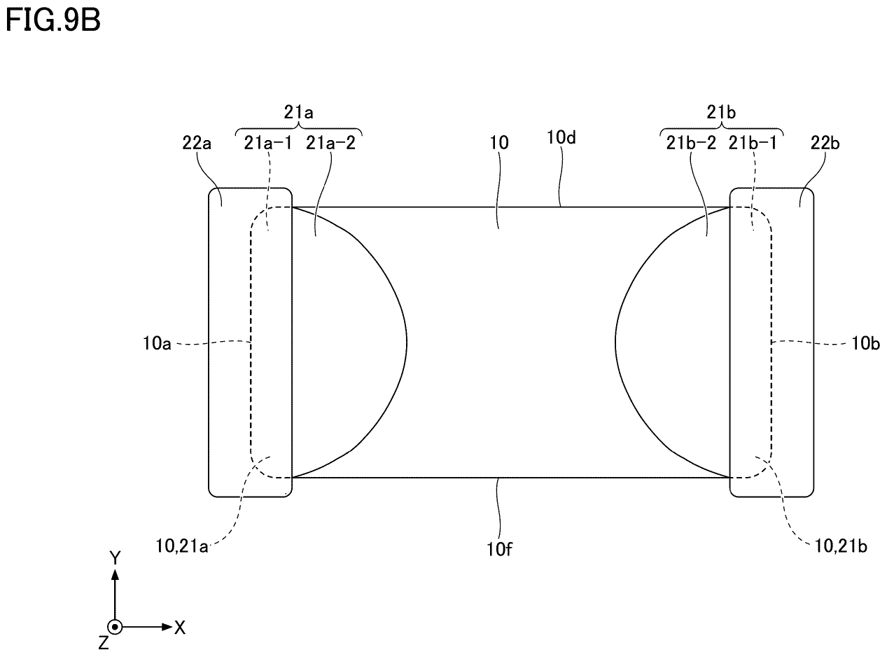

FIG. 9A is a plan view illustrating an example of a multilayer ceramic capacitor according to a fourth embodiment. FIG. 9B is a schematic explanatory view illustrating the relationship between the first metal layers and the second metal layers, in which the plating layers illustrated in FIG. 9A are omitted.

A multilayer ceramic capacitor 100 according to the fourth embodiment is the same as the multilayer ceramic capacitor 100 according to the first embodiment, except that the shapes of the metal base layers 20a and 20b are changed to those illustrated in FIG. 9A and FIG. 9B. Hereinafter, the differences of the multilayer ceramic capacitor 100 according to the fourth embodiment from the multilayer ceramic capacitor 100 according to the first embodiment will be described.

In the multilayer ceramic capacitor 100 according to the fourth embodiment, the linear distance E1 consists of a region where only the corresponding one of the plating layers 23a and 23b is disposed.

### Fifth Embodiment

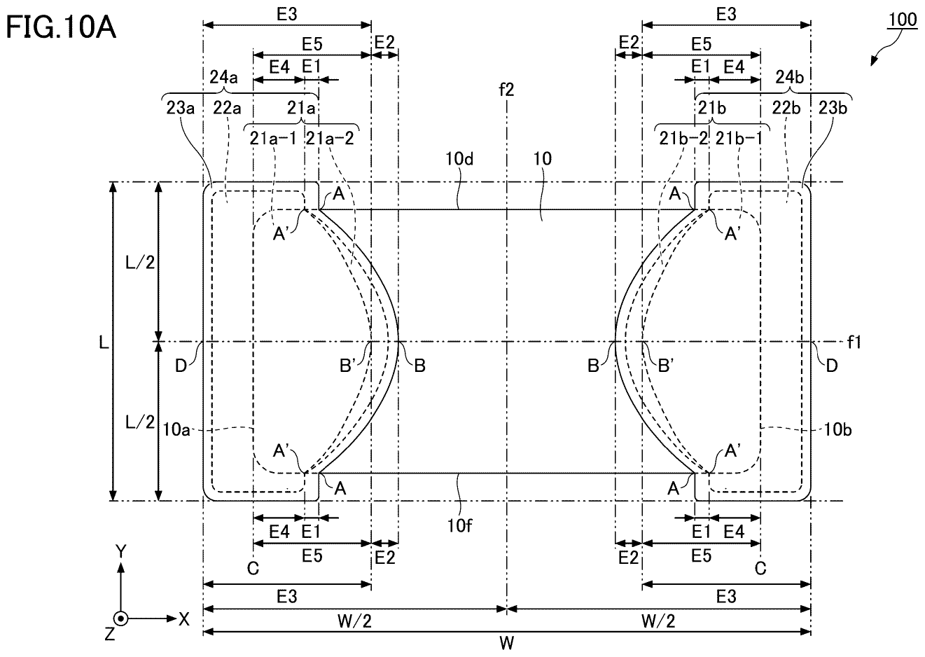

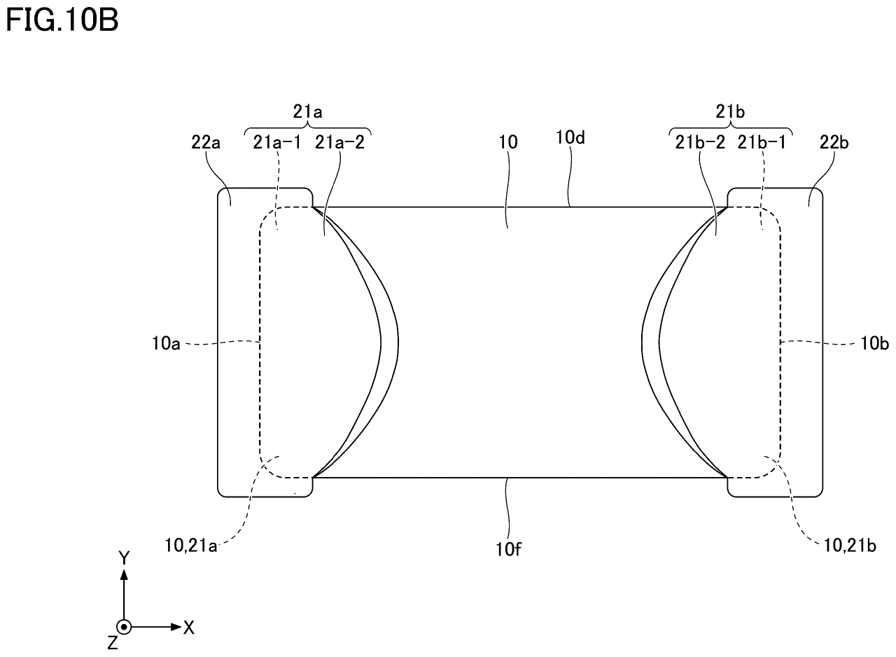

FIG. 10A is a plan view illustrating an example of a multilayer ceramic capacitor according to a fifth embodiment. FIG. 10B is a schematic explanatory view illustrating the relationship between the first metal layers and the second metal layers, in which the plating layers illustrated in FIG. 10A are omitted.

A multilayer ceramic capacitor 100 according to the fifth embodiment is the same as the multilayer ceramic capacitor 100 according to the second embodiment, except that the shapes of the metal base layers 20a and 20b are changed to those illustrated in FIG. 10A and FIG. 10B. Hereinafter, the differences of the multilayer ceramic capacitor 100 according to the fifth embodiment from the multilayer ceramic capacitor 100 according to the second embodiment will be described.

In the multilayer ceramic capacitor 100 according to the fifth embodiment, the linear distance E1 consists of a region where only the corresponding one of the plating layers 23a and 23b is disposed.

### Sixth Embodiment

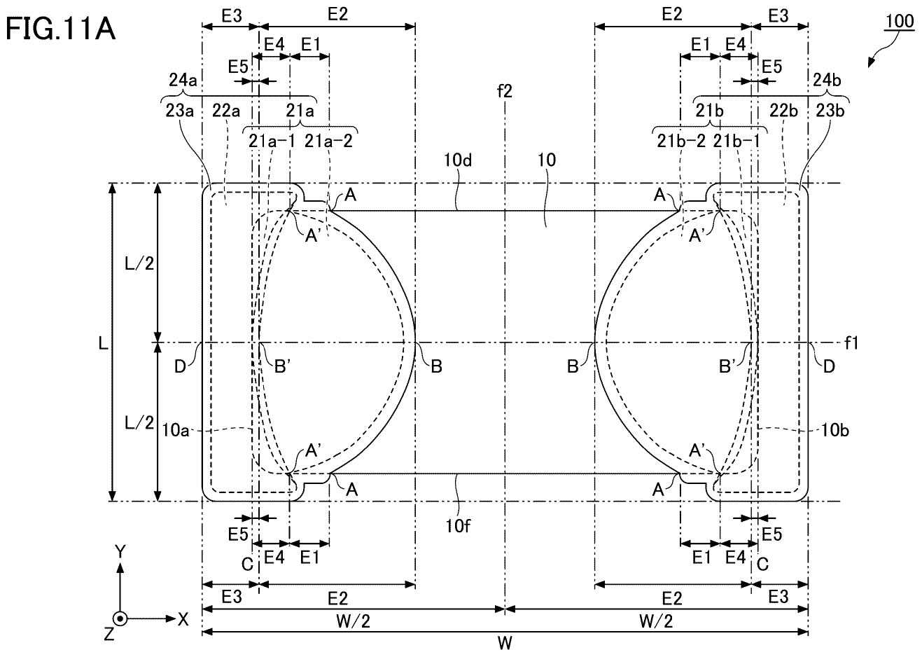

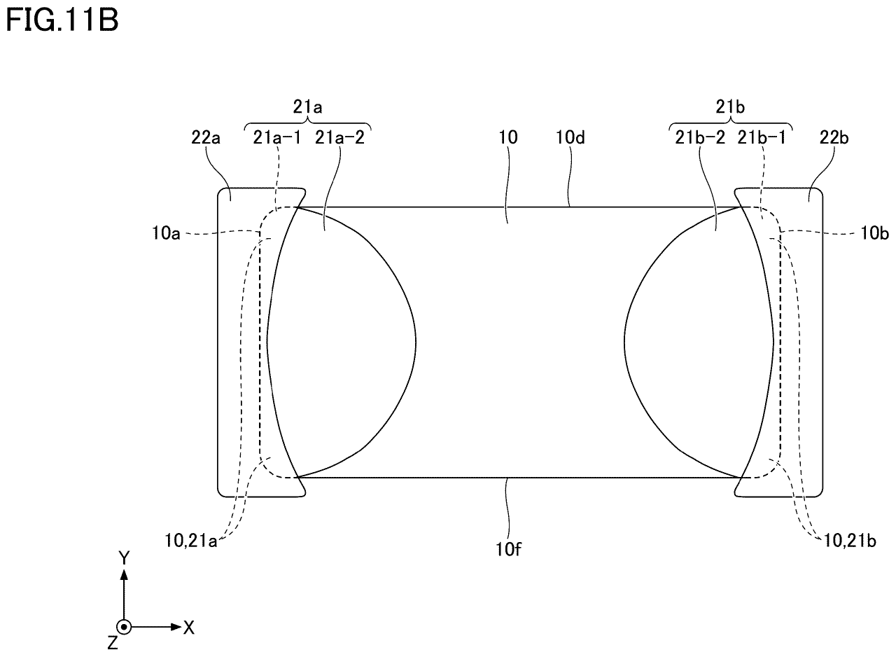

FIG. 11A is a plan view illustrating an example of a multilayer ceramic capacitor according to a sixth embodiment. FIG. 11B is a schematic explanatory view illustrating the relationship between the first metal layers and the second metal layers, in which the plating layers illustrated in FIG. 11A are omitted.

A multilayer ceramic capacitor 100 according to the sixth embodiment is the same as the multilayer ceramic capacitor 100 according to the third embodiment, except that the shapes of the metal base layers 20a and 20b are changed to those illustrated in FIG. 11A and FIG. 11B. Hereinafter, the differences of the multilayer ceramic capacitor 100 according to the sixth embodiment from the multilayer ceramic capacitor 100 according to the third embodiment will be described.

In the multilayer ceramic capacitor 100 according to the sixth embodiment, the linear distance E1 consists of a region where only the corresponding one of the plating layers 23a and 23b is disposed.

### Seventh Embodiment

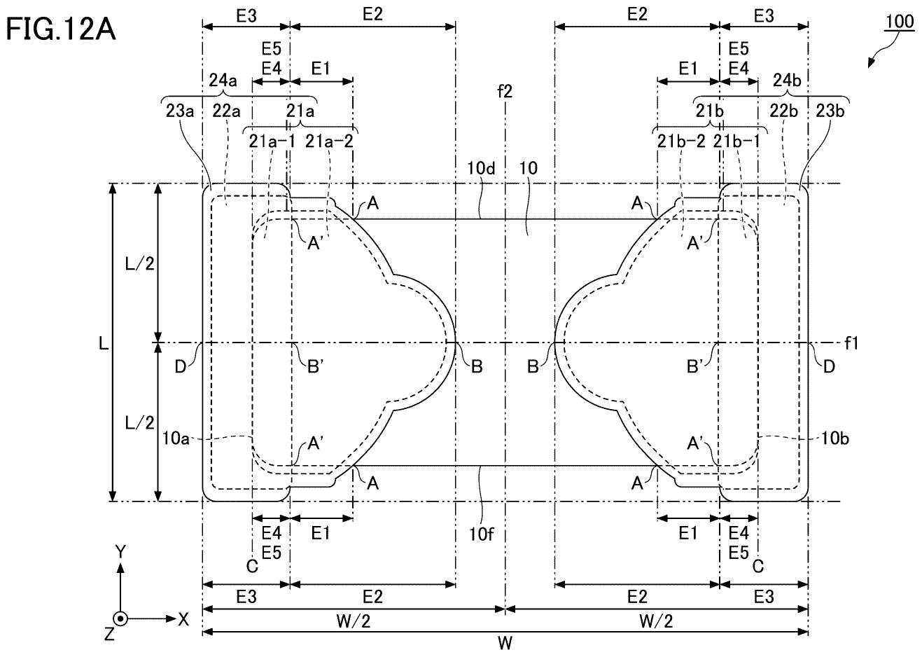

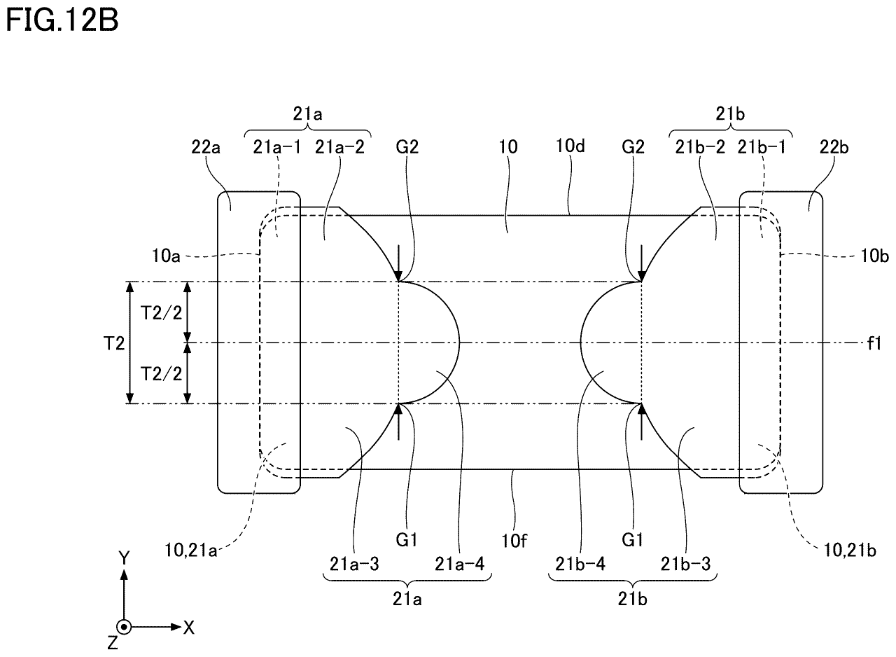

FIG. 12A is a plan view illustrating an example of a multilayer ceramic capacitor according to a seventh embodiment. FIG. 12B is a schematic explanatory view illustrating the relationship between the first metal layers and the second metal layers, in which the plating layers illustrated in FIG. 12A are omitted.

A multilayer ceramic capacitor 100 according to the seventh embodiment is the same as the multilayer ceramic capacitor 100 according to the first embodiment, except that the shapes of the metal base layers 20a and 20b are changed to those illustrated in FIG. 12A and FIG. 12B. Hereinafter, the differences of the multilayer ceramic capacitor 100 according to the seventh embodiment from the multilayer ceramic capacitor 100 according to the first embodiment will be described.

In a plan view of at least one surface of the element body 10 having the first metal layers 21a and 21b, the second region 21a-2 includes a first exposed region 21a-3 and a second exposed region 21a-4 and the second region 21b-2 includes a first exposed region 21b-3 and a second exposed region 21b-4.

Portions of the outer peripheries defining the first exposed regions 21a-3 and 21b-3 are boundaries between the first regions 21a-1 and 21b-1 and the second regions 21a-2 and 21b-2, respectively, and other portions of the outer peripheries defining the first exposed regions 21a-3 and 21b-3 have curved shapes projecting from the first region 21a-1 side and the first region 21b-1 side toward the center portion of the element body 10, respectively.

The outer periphery defining each of the second exposed regions 21a-4 and 21b-4 has a first intersection point G1 with a corresponding one of the first exposed regions 21a-3 and 21b-3 and a second intersection point G2 with the corresponding one of the first exposed regions 21a-3 and 21b-3, and a portion of the outer periphery defining each of the second exposed regions 21a-4 and 21b-4 has a curved shape extending between the first intersection point G1 and the second intersection point G2 and projecting from the corresponding one of the first exposed regions 21a-3 and 21b-3 toward the center portion of the element body.

The first intersection point G1 and the second intersection point G2 are preferably arranged with the imaginary straight line f1 interposed therebetween, and also the first intersection point G1 and the second intersection point G2 are preferably arranged at positions symmetrical to each other with respect to the imaginary straight line f1 serving as an axis of symmetry.

A position T2/2 bisecting a linear distance T2 between the first intersection point G1 and the second intersection point G2 is preferably located on the imaginary straight line f1. Further, the apex of the curved shape of each of the second exposed regions 21a-4 and 21b-4 is preferably located at a position corresponding to the position T2/2. Thus, an alignment effect is suitably obtained.

The first exposed regions 21a-3 and 21b-3 and the second exposed regions 21a-4 and 21b-4 may have the same composition or may have different compositions as long as the effects of the first metal layers 21a and 21b can be obtained, and preferably have the same composition from the viewpoint of ease of manufacturing.

The ratio of the linear distance T2 to the maximum length L is not particularly limited and can be appropriately selected according to the intended purpose, and is preferably in a range of 10% to 40%, and more preferably in a range of 20% to 30%.

The linear distance T2 is not particularly limited as long as the linear distance T2 is smaller than the length of the end surfaces 10a and 10b of the element body 10 (In FIG. 12B, the length of the element body 10 in the Y-axis direction). The linear distance T2 can be appropriately adjusted according to the size of the multilayer ceramic capacitor 100, and is preferably in a range of 50 μm to 500 μm, and more preferably in a range of 100 μm to 250 μm. For example, the linear distance T2 can be measured as follows. In a plane perpendicular to a surface of the element body 10 having the first metal layers 21a and 21b, a sample is prepared by polishing or cutting the multilayer ceramic capacitor along the X-axis direction from the end surfaces 10a and 10b side of the element body 10 to a region having the first intersection point G1 and the second intersection point G2. Then, in the exposed cross-section, the length from the first intersection point G1 to the second intersection point G2 can be measured by, for example, a microscope.

### Eighth Embodiment

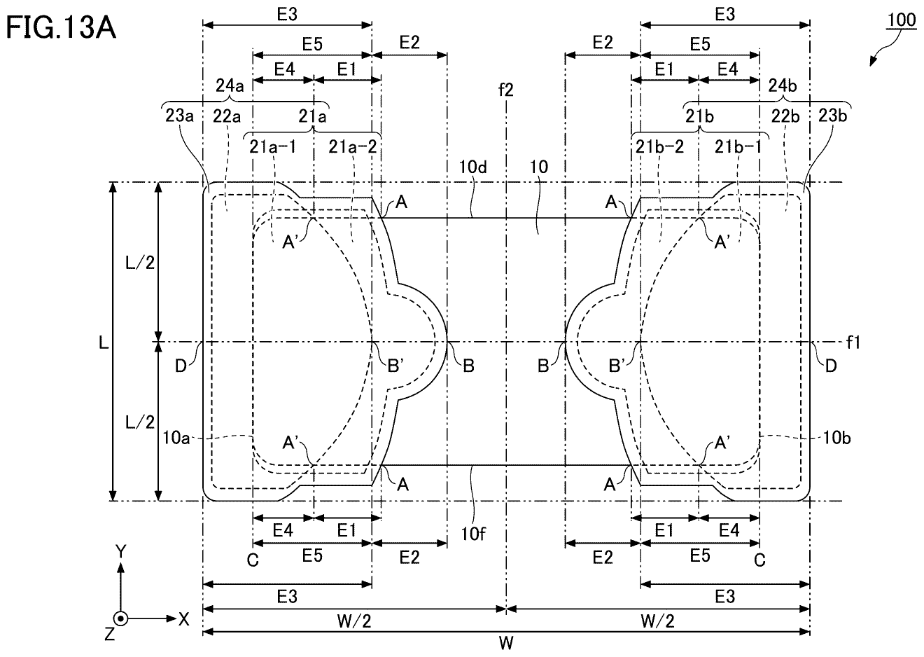

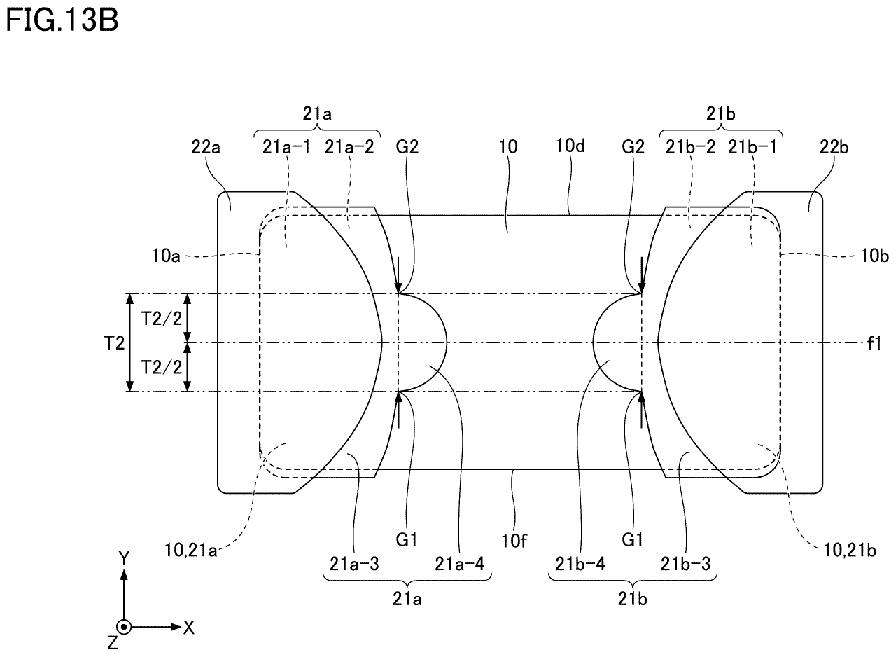

FIG. 13A is a plan view illustrating an example of a multilayer ceramic capacitor according to an eighth embodiment. FIG. 13B is a schematic explanatory view illustrating the relationship between the first metal layers and the second metal layers, in which the plating layers illustrated in FIG. 13A are omitted.

A multilayer ceramic capacitor 100 according to the eighth embodiment is the same as the multilayer ceramic capacitor 100 according to the second embodiment or the multilayer ceramic capacitor 100 according to the seventh embodiment, except that the shapes of the metal base layers 20a and 20b are changed to those illustrated in FIG. 13A and FIG. 13B. Hereinafter, the differences of the multilayer ceramic capacitor 100 according to the eighth embodiment from the multilayer ceramic capacitor 100 according to the second embodiment or the multilayer ceramic capacitor 100 according to the seventh embodiment will be described.

In the multilayer ceramic capacitor 100 according to the second embodiment, the linear distance E1 and the linear distance E2 satisfy Equation 4. In the multilayer ceramic capacitor 100 according to the eighth embodiment, the multilayer ceramic capacitor 100 have second exposed regions 21a-4 and 21b-4, and thus the linear distance E1 and the linear distance E2 satisfy Equation 2.

### Ninth Embodiment

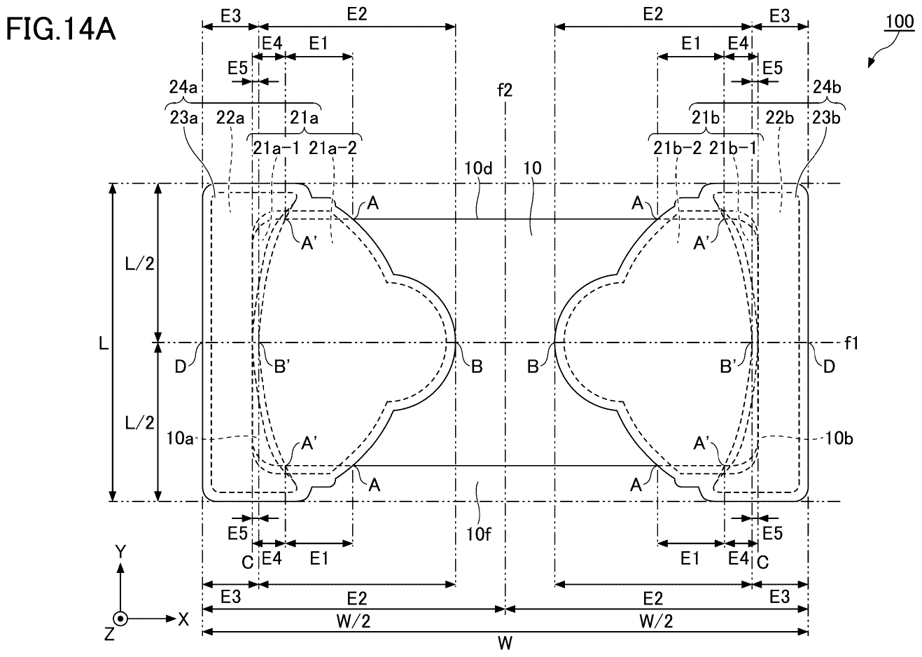

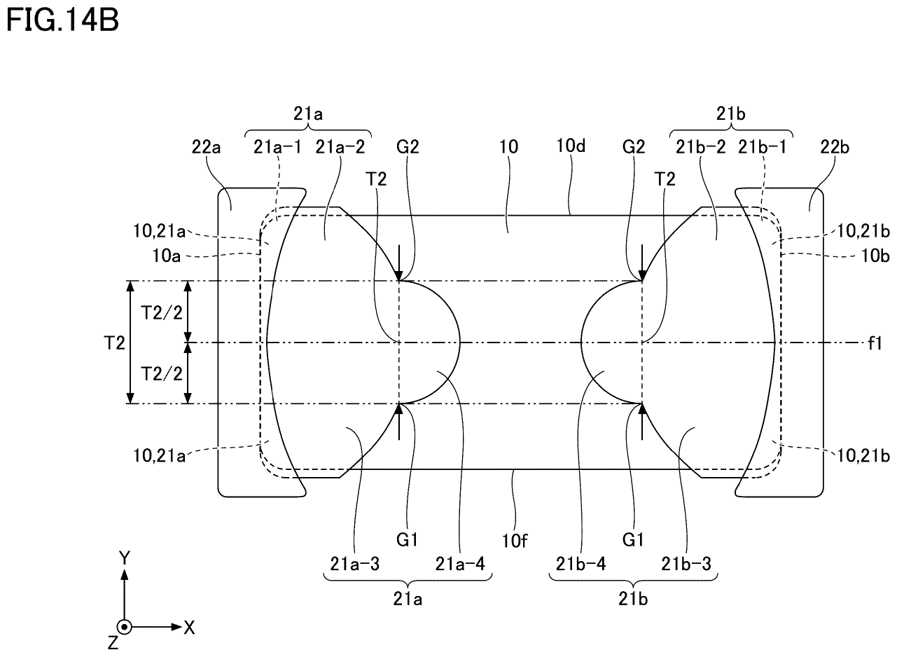

FIG. 14A is a plan view illustrating an example of a multilayer ceramic capacitor according to a ninth embodiment. FIG. 14B is a schematic explanatory view illustrating the relationship between the first metal layers and the second metal layers, in which the plating layers illustrated in FIG. 14A are omitted.

A multilayer ceramic capacitor 100 according to the ninth embodiment is the same as the multilayer ceramic capacitor 100 according to the third embodiment or the multilayer ceramic capacitor 100 according to the seventh embodiment, except that the shapes of the metal base layers 20a and 20b are changed to those illustrated in FIG. 14A and FIG. 14B.

In the multilayer ceramic capacitor 100 according to the third embodiment, the linear distance E1 and the linear distance E2 satisfy Equation 2. In the multilayer ceramic capacitor 100 according to the ninth embodiment, the linear distance E1 and the linear distance E2 also satisfy Equation 2, but the multilayer ceramic capacitor 100 according to the ninth embodiment has second exposed regions 21a-4 and 21b-4, and thus the linear distance E2 with respect to the linear distance E1 is larger than that in the multilayer ceramic capacitor 100 according to the third embodiment. Therefore, the multilayer ceramic capacitor 100 according to the ninth embodiment can more suitably suppress positional displacement.

### Tenth Embodiment

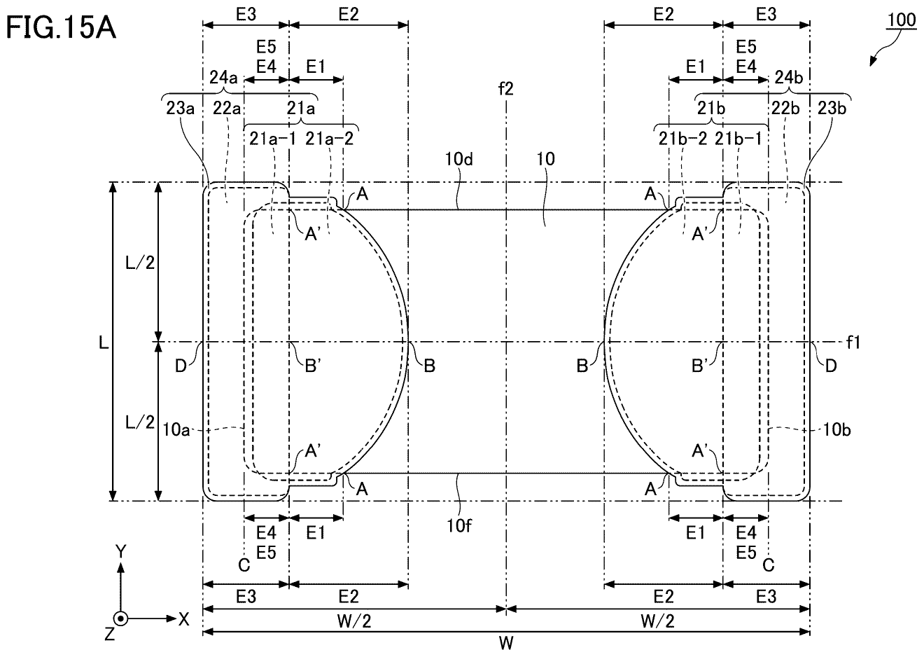

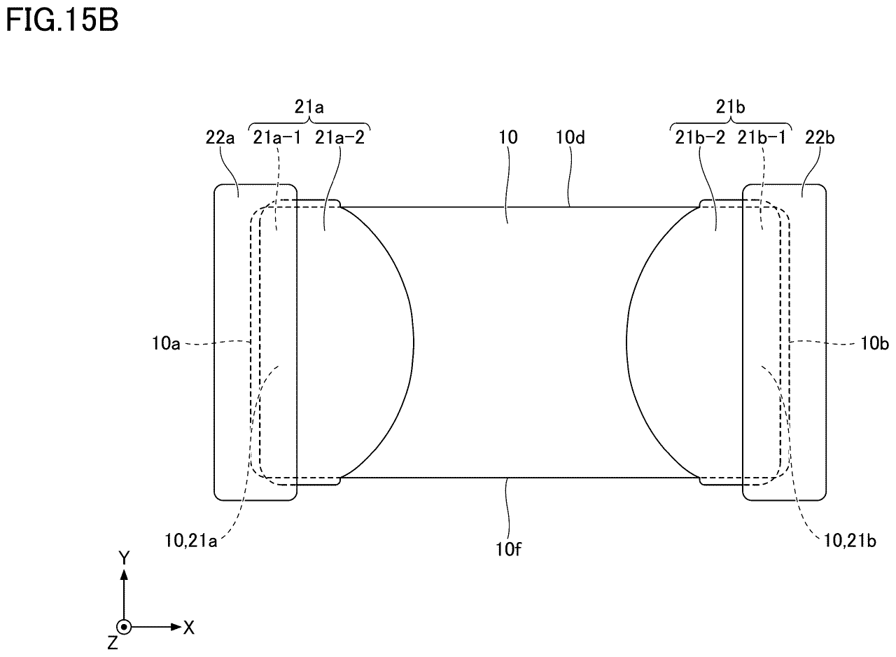

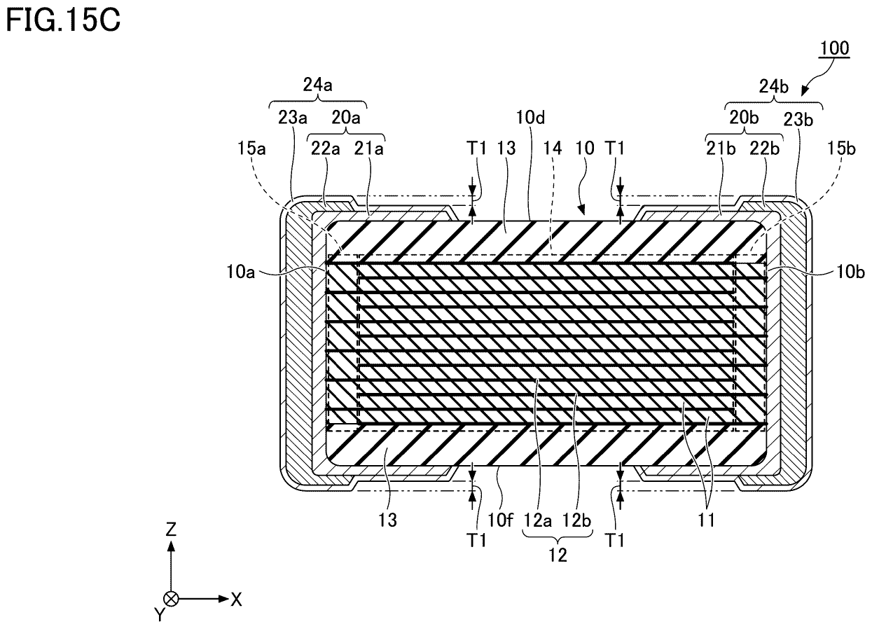

FIG. 15A is a plan view illustrating an example of a multilayer ceramic capacitor according to a tenth embodiment. FIG. 15B is a schematic explanatory view illustrating the relationship between the first metal layers and the second metal layers, in which the plating layers illustrated in FIG. 15A are omitted. FIG. 15C is a cross-sectional view illustrating a cross section taken along the imaginary straight line f1 of FIG. 15A.

A multilayer ceramic capacitor 100 according to the tenth embodiment is the same as the multilayer ceramic capacitor 100 according to the first embodiment, except that the shapes of the metal base layers 20a and 20b are changed to those illustrated in FIG. 15A, FIG. 15B, and FIG. 15C.

The multilayer ceramic capacitor 100 according to the tenth embodiment is the same as the multilayer ceramic capacitor 100 according to the first embodiment, except that first metal layers 21a and 21b are disposed so as to continuously cover a region extending from the end surfaces 10a and 10b of the element body 10 to portions of the four surfaces 10c, 10d, 10e, and 10f of the element body 10, and that the second metal layers 22a and 22b are disposed so as to continuously cover a region extending from the first metal layers 21a and 21b disposed on the end surfaces 10a and 10b of the element body to portions on the end surface 10a side and the end surface 10b side of the first metal layers 21a and 21b disposed on the four surfaces 10c, 10d, 10e, and 10f.

In the multilayer ceramic capacitor 100 according to the tenth embodiment, because the end surfaces 10a and 10b are covered by the first metal layers 21a and 21b and the second metal layers 22a and 22b, the end surfaces 10a and 10b of the element body 10 can be more suitably prevented from being damaged.

### Comparative Embodiment

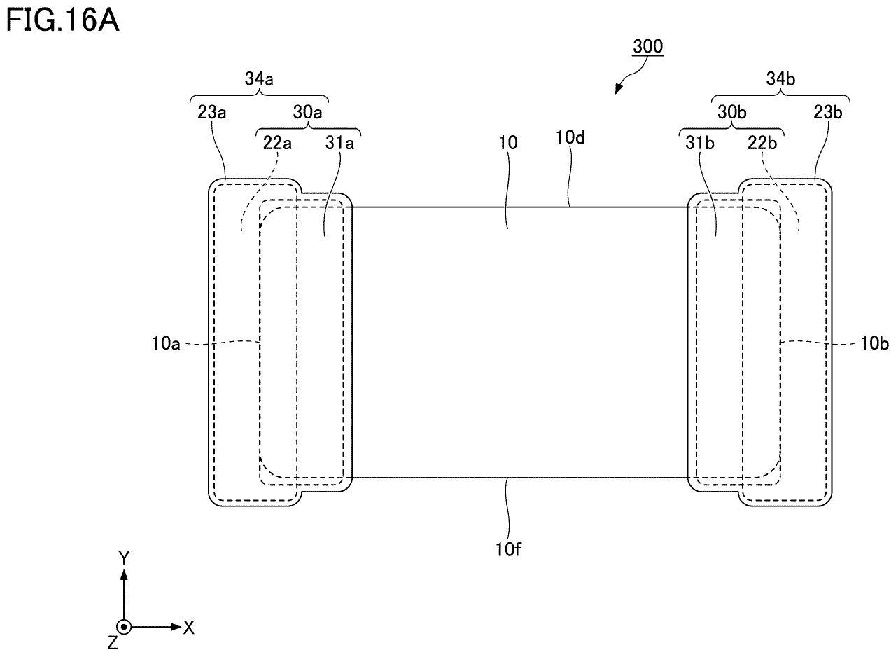

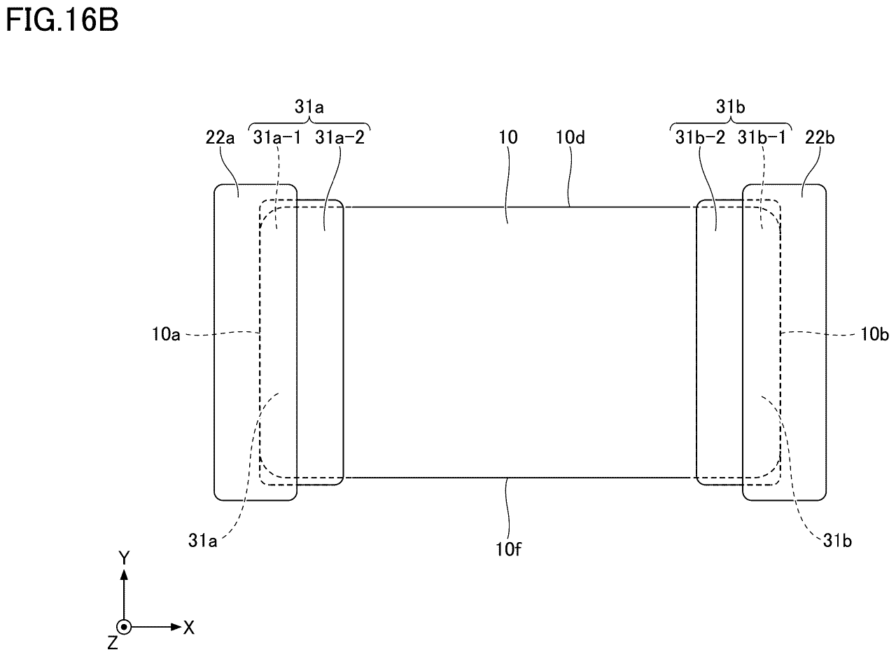

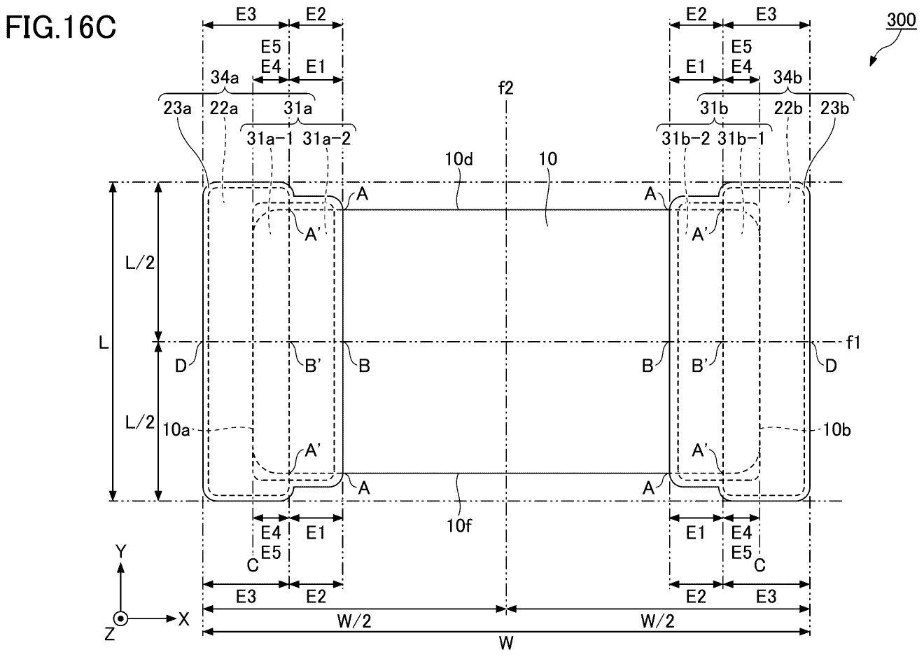

FIG. 16A is a plan view illustrating an example of a multilayer ceramic capacitor according to a comparative embodiment. FIG. 16B is a schematic explanatory view illustrating the relationship between first metal layers and second metal layers, in which plating layers illustrated in FIG. 16A are omitted. FIG. 16C is a schematic explanatory view illustrating the size of each part illustrated in FIG. 16A.

A multilayer ceramic capacitor 300 according to the comparative embodiment is similar to the multilayer ceramic capacitors 100 according to the first embodiment to the tenth embodiment, except that the metal base layers 20a and 20b of the external electrodes 24a and 24b of each of the multilayer ceramic capacitors 100 according to the first embodiment to the tenth embodiment are changed to metal base layers 30a and 30b of external electrodes 34a and 34b having shapes illustrated in FIG. 16A and FIG. 16B. Specifically, the multilayer ceramic capacitor 300 according to the comparative embodiment is similar to the multilayer ceramic capacitors 100 according to the first embodiment to the tenth embodiment, except that the shapes of the first metal layers 21a and 21b of each of the multilayer ceramic capacitors 100 according to the first embodiment to the tenth embodiment are changed to the shapes of the first metal layers 31a and 31b illustrated in FIG. 16A and FIG. 16B, respectively. The multilayer ceramic capacitor 300 according to the comparative embodiment is an example of a conventional multilayer ceramic capacitor.

In the multilayer ceramic capacitor 300 according to the comparative embodiment, a linear distance E1 and a linear distance E2 do not satisfy Equation 1, and E1=E2.

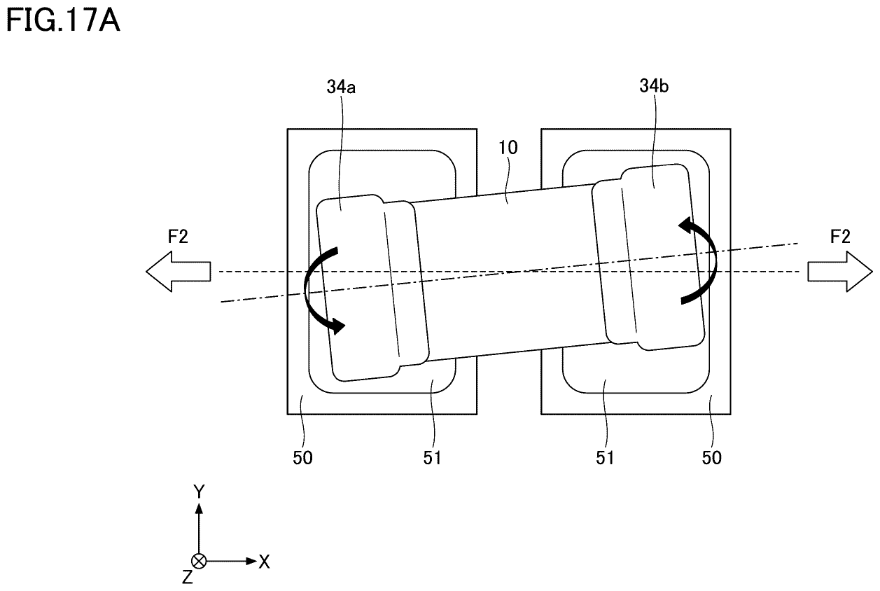

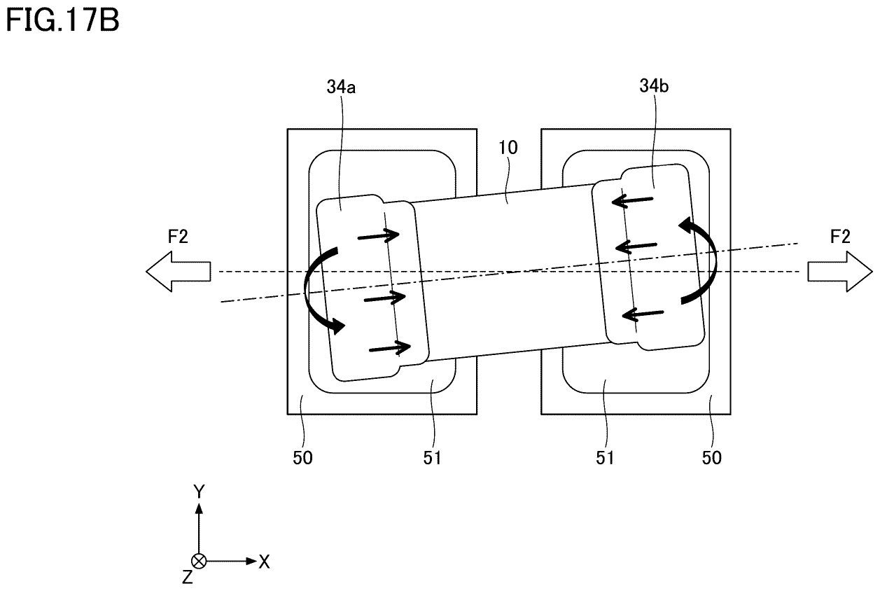

FIG. 17A and FIG. 17B are schematic top views when the multilayer ceramic capacitor according to the comparative embodiment is mounted by being fixed to a land part of a wiring pattern with solder. When the multilayer ceramic capacitor 300 according to the comparative embodiment is fixed to a land part 50 with solder 51, tension F2 (indicated by white arrows) is applied to the external electrodes 34a and 34b in the X-axis direction by the surface tension of the molten solder 51. Thus, a rotational moment (indicated by black arrows in FIG. 17A) is applied to the external electrodes 34a and 34b.

The multilayer ceramic capacitor 300 according to the comparative embodiment does not satisfy Equation 1 described above. Therefore, although the tension of the solder is concentrated at steps T1 from plating layers 23a and 23b disposed on second metal layers 22a and 22b toward the plating layers 23a and 23b disposed on the first metal layers 31a and 31b (as indicated by black arrows in FIG. 17B), the tension F2 cannot be canceled because no tension counteracting the rotational moment is generated. As a result, positional displacement of the multilayer ceramic capacitor 300 occurs.

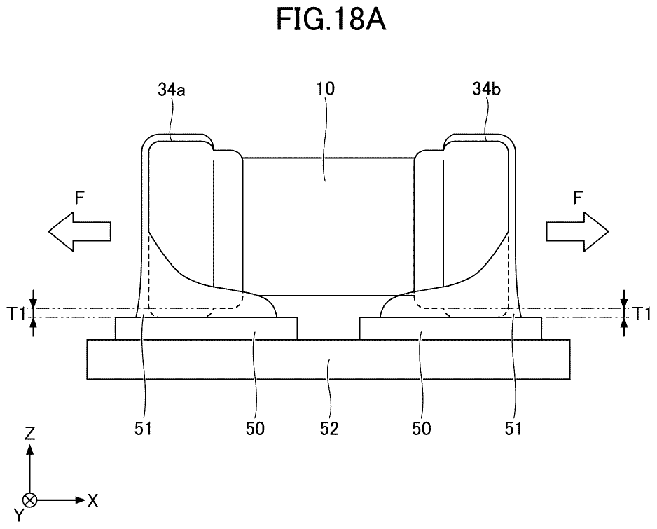

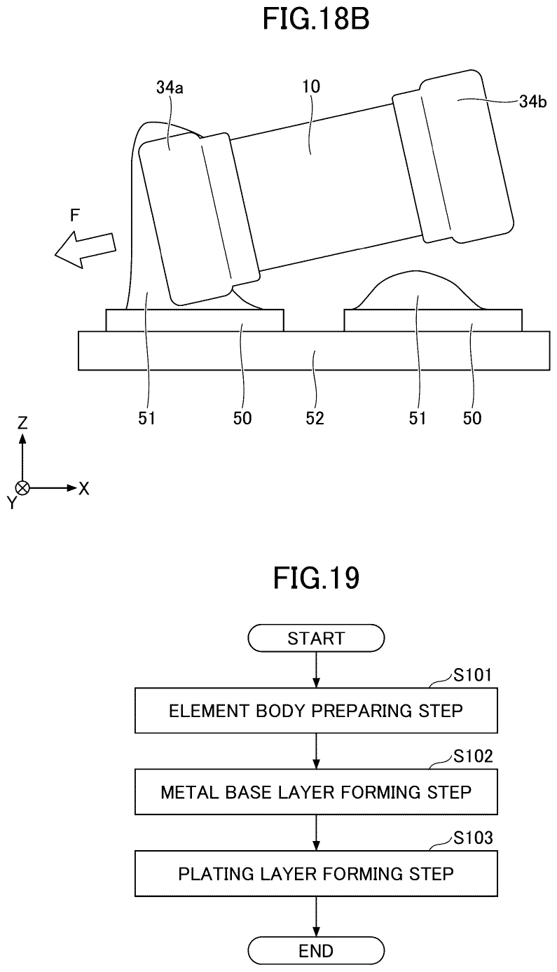

Next, FIG. 18A and FIG. 18B are schematic side views when the multilayer ceramic capacitor according to the comparative embodiment is mounted by being fixed to the land part of the wiring pattern with the solder. In the multilayer ceramic capacitor 300 according to the comparative embodiment, because E1=E2, a small amount of solder 51 enters gaps between the land part 50 and the plating layers 23a and 23b on the first metal layers 31a and 31b as compared to the multilayer ceramic capacitors 100 according to the first embodiment to the tenth embodiment. Therefore, wicking of excess solder 51 occurs along the surfaces on the end surface 10a side and the end surface 10b side of the plating layers 23a and 23b. The wicking of the excess solder 51 does not necessarily occur uniformly on the external electrode 34a side and the external electrode 34b side.

When the multilayer ceramic capacitor 300 is fixed to the land part 50 on a substrate body 52 with the solder 51, tension F (indicated by white arrows in FIG. 18A) is applied to the external electrodes 34a and 34b in the X-axis direction by the surface tension of the molten solder 51. At this time, the tension F becomes greater on the side where the wicking of the excess solder 51 is more significant. In FIG. 18A, the tension F of the solder 51 on the external electrode 34a side is greater. As a result, the tombstone phenomenon occurs.

### Method of Manufacturing Multilayer Ceramic Capacitor

A method of manufacturing a multilayer ceramic electronic component according to an embodiment of the present disclosure includes an element body preparing step; a metal base layer forming step; and a plating layer forming step. The method of manufacturing the multilayer ceramic electronic component according to the present disclosure may further include other steps as necessary.

FIG. 19 is a flowchart illustrating an example of the method of manufacturing the multilayer ceramic electronic component according to the embodiment of the present disclosure.

### (Step S101: Element Body Preparing Step)

In the element body preparing step (step S101), an element body 10 in which a plurality of internal electrodes 12 and a plurality of dielectric layers 11 containing a ceramic as a component are alternately laminated, and that has a pair of end surfaces 10a and 10b and four surfaces 10c, 10d, 10e, and 10f connected to the end surfaces 10a and 10b, is prepared. The pair of end surfaces 10a and 10b face in the first direction and the plurality of laminated internal electrodes 12 are alternately exposed at the pair of end surfaces 10a and 10b.

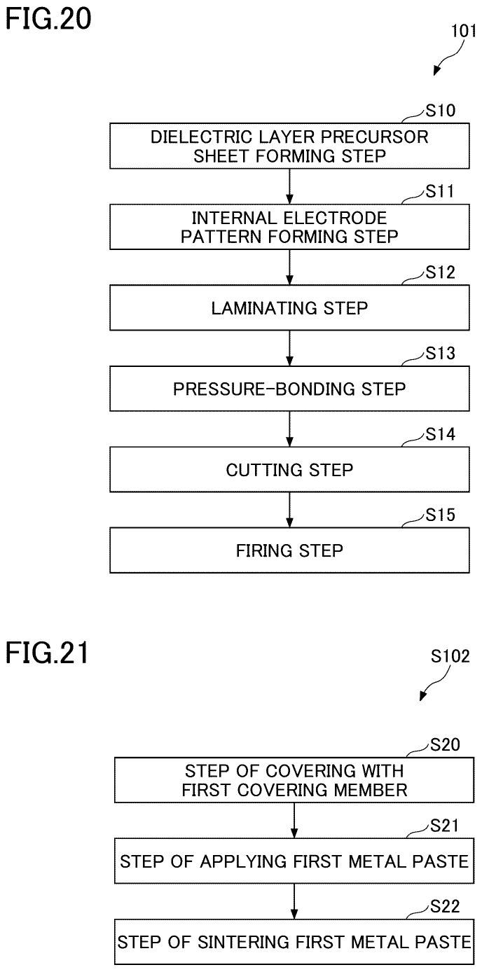

FIG. 20 is a flowchart illustrating an example of the element body preparing step of the manufacturing method of the multilayer ceramic electronic component according to the embodiment of the present disclosure. The element body preparing step may include a dielectric layer precursor sheet forming step, an internal electrode pattern forming step, a laminating step, a pressure-bonding step, a cutting step, and a firing step.

### <Step S10: Dielectric Layer Precursor Sheet Forming Step>

In the dielectric layer precursor sheet forming step (step S10), for example, a dielectric material is prepared by adding various additive compounds (such as a sintering aid) to a raw material powder for ceramic. Examples of the raw material powder for ceramic, used for the dielectric material, include a material from which a ceramic containing a compound having a perovskite structure and represented by the general formula ABO_{3-α} (0≤α≤1) can be obtained. For example, barium titanate (BaTiO₃) is a tetragonal compound having a perovskite structure, and exhibits a high relative dielectric constant. In general, barium titanate can be obtained by reacting a titanium source such as titanium dioxide with a barium source such as barium carbonate.

As a method of synthesizing the raw material powder for ceramic, various methods have been known, such as a solid phase method, a sol-gel method, a hydrothermal method, and the like. In the embodiment of the present disclosure, any of these methods can be adopted.

The average particle size of the raw material powder for ceramic is preferably in a range of 50 nm to 200 nm from the viewpoint of making the dielectric layers 11 thinner.

To prepare the dielectric material, a predetermined additive can be added to the raw material powder for ceramic according to intended purpose. Examples of an additive compound include: one or more elements selected from the group consisting of zirconium (Zr), niobium (Nb), molybdenum (Mo), tantalum (Ta), tungsten (W), magnesium (Mg), manganese (Mn), vanadium (V), and chromium (Cr); oxides including one or more rare earth elements selected from the group consisting of scandium (Sc), yttrium (Y), cerium (Ce), neodymium (Nd), samarium (Sm), europium (Eu), gadolinium (Gd), terbium (Tb), dysprosium (Dy), holmium (Ho), erbium (Er), thulium (Tm), and ytterbium (Yb); oxides including one or more elements selected from cobalt (Co), nickel (Ni), lithium (Li), boron (B), sodium (Na), potassium (K), and silicon (Si); and glass including one or more elements selected from the group consisting of cobalt (Co), nickel (Ni), lithium (Li), boron (B), sodium (Na), potassium (K), and silicon (Si). These may be used alone or in combination. Among them, silicon dioxide (SiO₂), which is an oxide of silicon (Si), suitably functions as a sintering aid.

Examples of a method of preparing the dielectric material includes a method of preparing the dielectric material by wet-mixing a compound including an additive and an additive compound with the raw material powder for ceramic as necessary, followed by drying and pulverizing the raw material powder. Further, after the raw material powder is dried and pulverized, the raw material powder may be subjected to pulverizing treatment to adjust the particle size, or may be combined with classification treatment to adjust the particle size.

Next, an organic binder, an organic solvent, a plasticizer, and the like are added to the prepared dielectric material and wet-mixed to form a slurry. The organic binder is not particularly limited, and a publicly-known resin such as a polyvinyl butyral (PVB) resin or the like can be used. The organic solvent is not particularly limited, and examples of the organic solvent include ethanol, toluene, and the like.

A method of preparing the slurry is not particularly limited, and examples of the method of preparing the slurry include a method of wet-mixing the dielectric material, the organic binder, the organic solvent, and the plasticizer. Note that, when the raw material powder for ceramic and the like are mixed for the preparation of the dielectric material, an organic binder or the like may be added and wet-mixed together.

Next, the slurry is coated on a substrate. For example, the obtained slurry can be coated on the substrate by a die coater or a doctor blade. Subsequently, the substrate on which the slurry is coated is dried to form a dielectric layer precursor sheet. One example of the dielectric layer precursor sheet is a ceramic precursor sheet. The thickness of the dielectric layer precursor sheet can be appropriately selected according to the intended average thickness of each of the dielectric layers 11.

The substrate is not particularly limited, and is preferably formed of a material from which the dielectric layer precursor sheet can be peeled off. The substrate is, for example, a polyethylene terephthalate (PET) film.

### <Step S11: Internal Electrode Pattern Forming Step>

In the internal electrode pattern forming step (step S11), metal patterns to be the internal electrodes 12 are formed on the dielectric layer precursor sheet. Specifically, a conductor paste including an organic binder for internal electrode formation is printed on the dielectric layer precursor sheet through, for example, gravure printing. Thus, a plurality of metal patterns corresponding to the internal electrodes 12 are formed on the dielectric layer precursor sheet in a state of being spaced apart from each other.

The conductor paste can contain: a base metal such as nickel (Ni), copper (Cu), or tin (Sn), or an alloy containing the same; a metal powder serving as a main component of a noble metal, such as platinum (Pt), palladium (Pd), silver (Ag), or gold (Au), or an alloy containing the same; a binder; and an organic solvent. Further, the conductor paste can contain, as a co-existent material, ceramic particles of, for example, a compound having a perovskite structure and represented by the general formula ABO_{3-α} (0≤α≤1).

The conductive paste can be prepared by kneading a metal to be a main component and, as necessary, other components such as a co-existent material.

The conductor paste can be printed by a printing method such as screen printing or gravure printing. The method of forming internal electrode patterns in the internal electrode pattern forming step (step S11) is not limited to a printing method, and can be a plating method, a vacuum deposition method, a sputtering method, or a chemical vapor deposition (CVD) method. In this manner, a first internal electrode pattern for first internal electrodes 12a or a second internal electrode pattern for second internal electrodes 12b is formed on the surface of the dielectric layer precursor sheet.

Further, a dielectric pattern paste for a reverse pattern layer can be obtained by adding an organic binder, such as an ethyl cellulose-based organic binder, and an organic solvent, such as a terpineol-based organic solvent, to the dielectric material obtained in the dielectric layer precursor sheet forming step (step S10), followed by kneading using a roll mill. Then, a dielectric pattern may be placed by applying the dielectric pattern paste to a peripheral region of the dielectric layer precursor sheet where the first internal electrode pattern or the second internal electrode pattern is not formed, to fill a gap with the first internal electrode pattern or the second internal electrode pattern. The dielectric layer precursor sheet on which an internal electrode pattern and a dielectric pattern are formed is referred to as a lamination unit.

### <Step S12: Laminating Step>

In the laminating step (step S12), a laminate is formed by laminating, in the third direction, two or more dielectric layer precursor sheets on which internal electrode patterns are formed.

A dielectric layer precursor sheet on which the first internal electrode pattern and the dielectric pattern are formed and a dielectric layer precursor sheet on which the second internal electrode pattern and the dielectric pattern are formed are laminated in this order, while peeling the substrate from each of the dielectric layer precursor sheets. At this time, it is preferable to laminate lamination units such that the internal electrodes 12 and the dielectric layers 11 are alternately formed, and the edges of the internal electrode layers 12 are alternately exposed at the end surfaces 10a and 10b, facing in the longitudinal direction of the dielectric layers 11, so as to alternately extend to a pair of metal base layers 20a and 20b having different polarities.

The number of lamination units to be laminated is not particularly limited and can be appropriately selected according to the intended purpose. For example, the number of lamination units can be 100 layers to 500 layers.

In addition, a cover layer 13 may be further laminated on the upper and lower surfaces of a laminated body of the dielectric layer precursor sheets. The number of cover layers 13 to be laminated is not particularly limited and can be approximately selected according to the intended purpose. The number of cover layers 13 to be laminated can be, for example, two to ten. The material of the cover layer 13 may be the same as that of the dielectric layer precursor sheets, and an additive and an additive compound to be added to a raw material powder for ceramic may be different from that of the dielectric layer precursor sheets.

### <Step S13: Pressure-Bonding Step>

In the pressure-bonding step (step S13), a plurality of dielectric layer precursors are pressure-bonded by pressurizing the laminated body formed in the laminating step (step S12). The laminated body obtained in the laminating step (step S12), as described above, preferably the laminated body of the dielectric layer precursor sheets whose upper and lower surfaces are covered by the cover layer 13, is thermally bonded to form a laminate. As pressure bonding, for example, a hydrostatic press can be used.

### <Step S14: Cutting Step>

In the cutting step (step S14), the laminate obtained in the pressure-bonding step (step S13) is cut in the lamination direction so as to be singulated. As a result, a plurality of laminates are prepared, each having a pair of end surfaces 10a and 10b that face each other in the first direction and at which a plurality of first internal electrode patterns and a plurality of second internal electrode patterns are alternately exposed, and having four surfaces 10c, 10d, 10e, and 10f connected to the end surfaces 10a and 10b.

The method of cutting the laminate is not particularly limited, and an existing method such as a method using a cutting blade, dicing using a dicer, laser cutting or the like, can be used.

The size into which the laminate is singulated is not particularly limited and can be appropriately selected according to a desired size of the multilayer ceramic capacitor 100.

In a laminate obtained in the cutting step (step S14), the first internal electrode pattern is exposed at the end surface 10a and the second internal electrode pattern is exposed at the end surface 10b. After cutting, the laminate may be polished by a method such as barrel polishing or the like. Thus, the corners of the laminate are rounded.

### <Step S15: Firing Step>

In the firing step (step S15), the laminate is fired. The firing step (step S15) may be a step of firing only the laminate in accordance with a combination of a metal contained as a main component in the conductor paste used in the internal electrode pattern forming step (step S11) and a metal contained as a main component in a metal paste used in the metal base layer forming step (step S102). Alternatively, the firing step (step S15) may be a step of firing both the laminate and a first metal layer precursor and/or a second metal layer precursor after the metal base layer forming step (step S102).

A temperature at which the laminate is fired is not particularly limited. Preferably, the laminate is subjected to debinding treatment in a nitrogen gas atmosphere at 250° C. to 500° C., and is subsequently fired in a reducing atmosphere at 1,300° C. to 1,400° C. for about one hour. As a result, the laminate and particles of the first internal electrode pattern and the second internal electrode pattern are fired.

In the above-described manner, the element body 10 in which the plurality of internal electrodes 12 and the plurality of dielectric layers 11 containing a ceramic as a main component are alternately laminated, and that has the pair of end surfaces 10a and 10b and the four surfaces 10c, 10d, 10e, and 10f connected to the end surfaces 10a and 10b, is prepared. The pair of end surfaces 10a and 10b face each other in the first direction and the plurality of laminated internal electrodes 12 are alternately exposed at the pair of end surfaces 10a and 10b.

### (Step S102: Metal Base Layer Forming Step)

In the metal base layer forming step (step S102), metal base layers 20a and 20b extending from the pair of end surfaces 10a and 10b to portions of the four surfaces 10c, 10d, 10e, and 10f are formed.

FIG. 21 is a flowchart illustrating an example of the metal base layer forming step of the method of manufacturing the multilayer ceramic electronic component according to the embodiment of the present disclosure. The metal base layer forming step (step S102) includes a step of forming first metal layers 21a and 21b on portions of at least one surface of the four surfaces 10c, 10d, 10e, and 10f of the element body 10, and a step of forming second metal layers 22a and 22b continuously covering regions extending from the end surfaces 10a and 10b of the element body 10 to portions on the end surface 10a side and the end surface 10b side of the first metal layers 21a and 21b.

The metal base layer forming step preferably includes a step of covering with a first covering member, a step of applying a first metal paste, and a step of sintering the first metal paste.

<Step S20: Covering with First Covering Member>

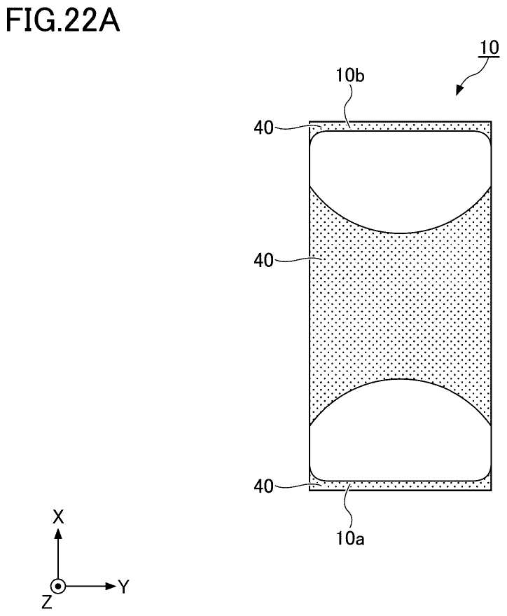

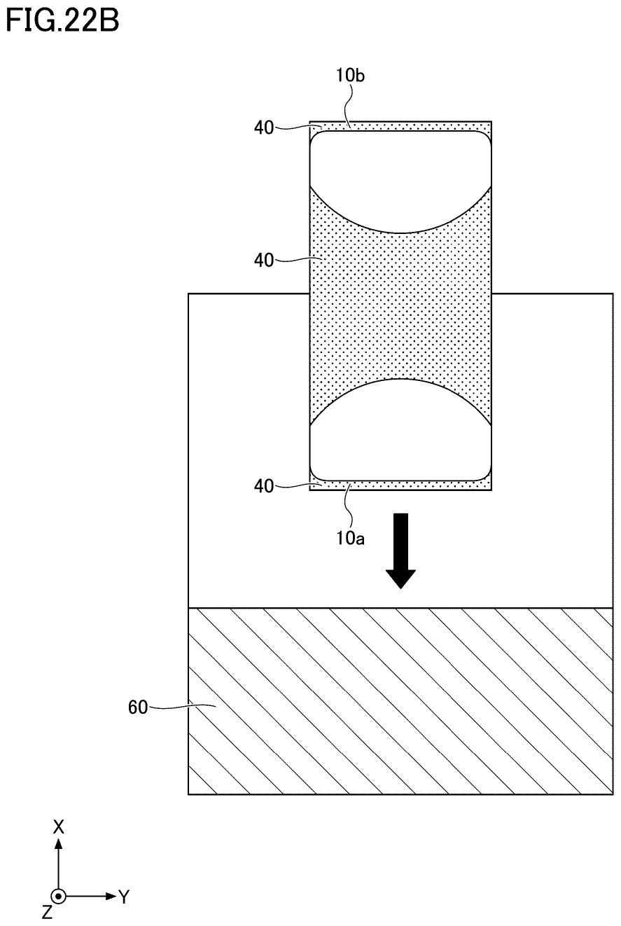

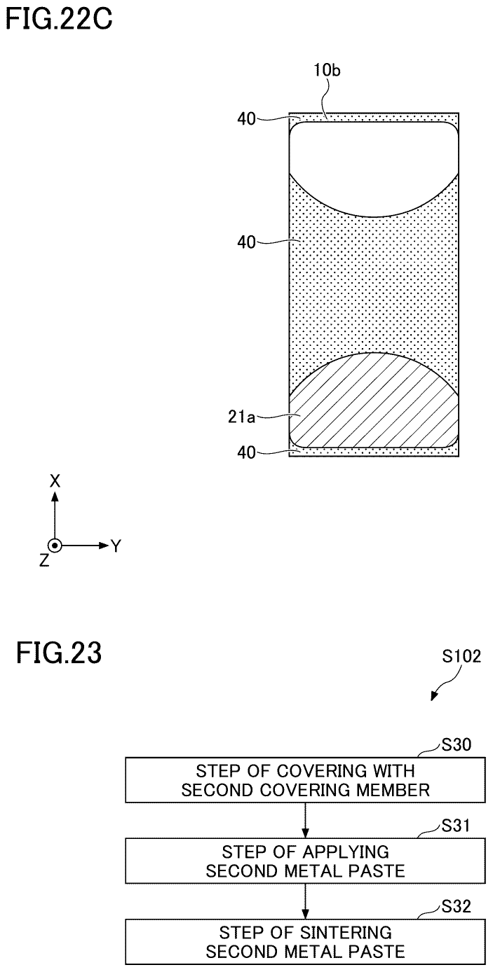

FIG. 22A is a schematic plan view illustrating an example of the step of covering with the first covering member in the metal base layer forming step of the method of manufacturing the multilayer ceramic electronic component according to the embodiment of the present disclosure.

In the step of covering with the first covering member (step S20), the element body 10 is covered with the first covering member having a desired shape. A first covering member 40 is disposed in a region of the element body 10 where the first metal layers 21a and 21b are not to be formed. Therefore, the first covering member 40 is disposed on the end surfaces 10a and 10b of the element body 10 and a center portion of the element body 10 in a shape corresponding to desired shapes of the first metal layers 21a and 21b. The shapes of the outer peripheries of the first metal layers 21a and 21b can be determined by the shape of the first covering member 40.

A material of the first covering member 40 is not particularly limited as long as the material does not react with the first metal paste and a second metal paste. The material of the first covering member 40 is preferably a material that can be peeled off from the element body 10, and is, for example, a publicly-known resist.

### <Step S21: Applying First Metal Paste>

FIG. 22B is a schematic plan view illustrating an example of the step of applying the first metal paste in the metal base layer forming step of the method of manufacturing the multilayer ceramic electronic component according to the embodiment of the present disclosure.

In the step of applying the first metal paste (step S21), the first metal paste is applied to a portion of at least one surface of the four surfaces 10c, 10d, 10e, and 10f of the element body 10.

A first metal paste 60 is applied to the end surface 10a side and the end surface 10b side of the element body 10 by a dip method, for example.

A main component of the first metal paste 60 is not particularly limited and can be appropriately selected according to the intended purpose from components that are typically used for the metal base layers of the multilayer ceramic capacitor. For example, when the first metal layers 21a and 21b are provided so as to improve electrical connection between the internal electrodes 12 and the metal base layers 20a and 20b, the main component of the conductive paste used in the internal electrode pattern forming step (step S11) may be used as the main component of the first metal paste 60. Further, for example, when the first metal layers 21a and 21b are provided so as to improve adhesion strength between the element body 10 and the metal base layers 20a and 20b, the main component of the first metal paste 60 preferably contains a metal containing a glass component containing Si as a main component.

The thickness of each of the first metal layers 21a and 21b can be adjusted by the amount of the first metal paste 60 applied. The number of times the first metal paste 60 is applied to adjust the thickness of each of the first metal layers 21 may be one or two or more.

In FIG. 22B, the first metal paste 60 is applied only to the end surface 10a side of the element body 10; however, the first metal paste 60 may be applied simultaneously to the end surface 10a side and the end surface 10b side of the element body 10.

### <Step S22: Sintering First Metal Paste>

FIG. 22C is a schematic plan view illustrating an example of the step of sintering the first metal paste in the metal base layer forming step of the method of manufacturing the multilayer ceramic electronic component according to the embodiment of the present disclosure.

In the step of sintering the first metal paste (step S22), the first metal paste 60 applied in the step of applying the first metal paste (step S21) is sintered.

The sintering temperature of the first metal paste 60 is not particularly limited and can be appropriately selected according to the composition of the first metal paste 60.

In a case where the main component of the first metal paste 60 is the same as that of the conductive paste used in the internal electrode pattern forming step (step S11), the sintering temperature can be the same as the firing temperature in the firing step (step S15). Further, the firing step (step S15) may be omitted and the first metal paste 60 may be sintered simultaneously with the sintering of the element body 10. In this case, the sintering conditions are the same as the firing conditions in the firing step (step S15).

Further, in a case where the main component of the first metal paste 60 is a metal containing a glass component containing Si as a main component, the sintering temperature is preferably in a range of 600° C. to 1,000° C., and more preferably in a range of 700° C. to 900° C.

Next, in the metal base layer forming step (step S102), the second metal layers 22a and 22b are formed so as to continuously cover regions extending from the end surfaces 10a and 10b of the element body 10 to portions on the end surface 10a side and the end surface 10b side of the first metal layers 21a and 21b, and so as to be electrically connected to the internal electrodes.

FIG. 23 is a flowchart illustrating an example of the metal base layer forming step of the method of manufacturing the multilayer ceramic electronic component according to the embodiment of the present disclosure. The metal base layer forming step (step S102) preferably further includes a step of covering with a second covering member, a step of applying the second metal paste, and a step of sintering the second metal paste.

<Step S30: Covering with Second Covering Member>

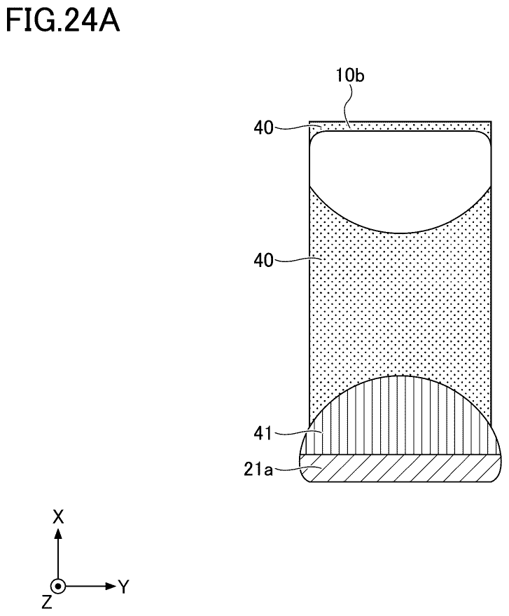

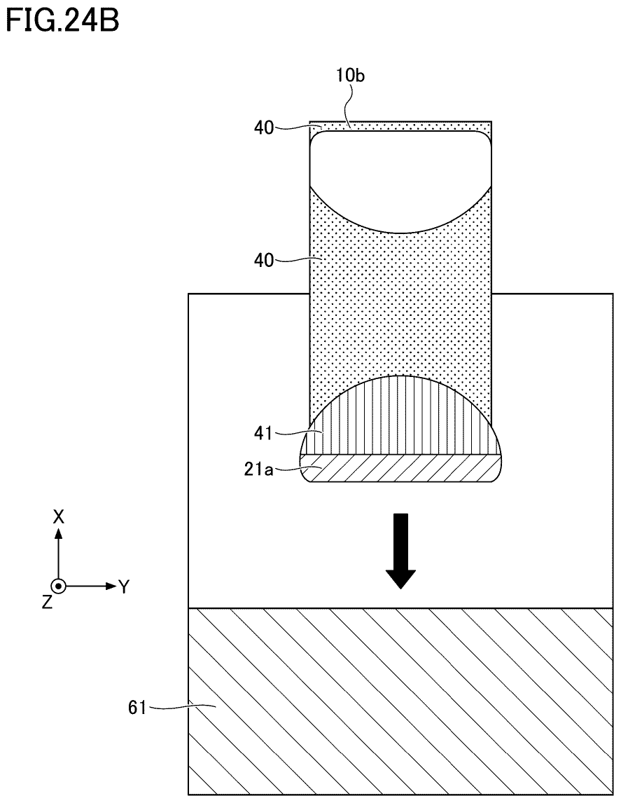

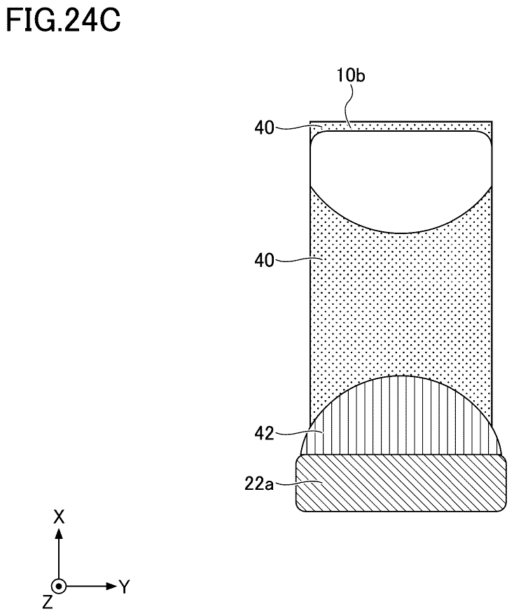

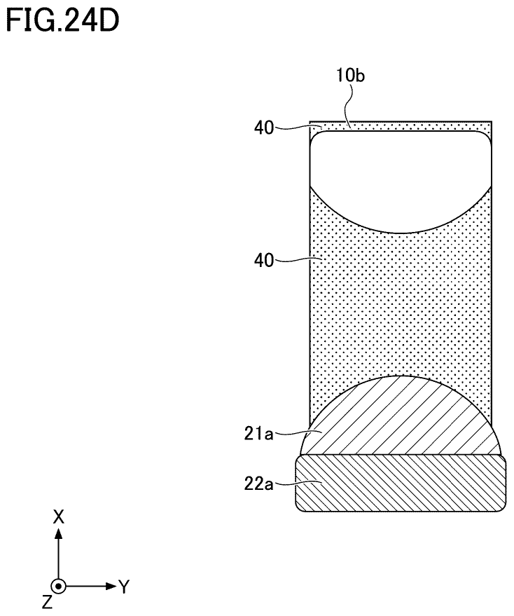

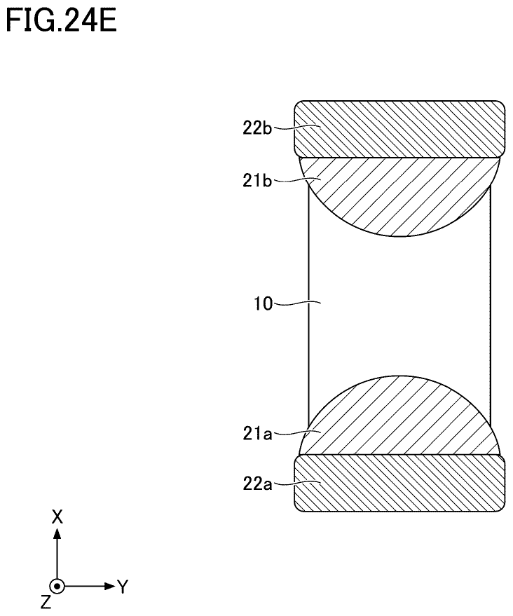

FIG. 24A is a schematic plan view illustrating an example of the step of covering with the second covering member in the metal base layer forming step of the method of manufacturing the multilayer ceramic electronic component according to the embodiment of the present disclosure.

In the step of covering with the second covering member (step S30), after the step of sintering the first metal paste (step S22), the first metal layers 21a and 21b are covered with a second covering member 41 having a desired shape. The second covering member 41 is disposed in a region where the second metal layers 22a and 22b are not formed. Therefore, the second covering member 41 is disposed in a shape corresponding to desired shapes of portions of the first metal layers 21a and 21b. The shapes of the outer peripheries of the second metal layers 22a and 22b can be determined by the shape of the second covering member 41.

A material of the second covering member 41 is not particularly limited as long as the material does not react with the second metal paste. The material of the second covering member 41 is preferably a material that can be peeled off from the first metal layers 21a and 21b. For example, the material of the second covering member 41 can be the same as the material of the first covering member 40.

In order to dispose the second metal layers 22a and 22b so as to be electrically connected to the internal electrodes 12, the first covering member 40 disposed on the end surfaces 10a and 10b of the element body 10 is peeled off before a second metal paste 61 is applied.

In FIG. 24A, the second covering member 41 is disposed only on the end surface 10a side of the element body 10 and the first covering member 40 is peeled off; however, the second covering member 41 may be disposed and the first covering member 40 may be peeled off simultaneously on the end surface 10a side and the end surface 10b side of the element body.

### <Step S31: Applying Second Metal Paste>

FIG. 24B is a schematic plan view illustrating an example of the step of applying the second metal paste in the metal base layer forming step of the method of manufacturing the multilayer ceramic electronic component according to the embodiment of the present disclosure.

In the step of applying the second metal paste (step S31), the second metal paste 61 is applied so as to continuously cover regions extending from the end surfaces 10a and 10b of the element body 10 to portions on the end surface 10a side and the end surface 10b side of the first metal layers 21a and 21b.

The second metal paste 61 is applied to the end surface 10a side and the end surface 10b side of the element body 10 by a dip method, for example.

A main component of the second metal paste 61 is not particularly limited and can be appropriately selected according to the intended purpose from components that are typically used for the external electrodes of the multilayer ceramic capacitor. For example, in order to improve the resistance of the second metal layers 22a and 22b to the plating layers 23a and 23b, a metal containing a glass component containing Si as a main component, Ni containing glass containing Ba as a main component, Cu containing glass containing Ba as a main component, Ni containing glass containing B as a main component, Cu containing glass containing B as a main component, or the like can be used as the second metal paste 61.

The main component of the first metal paste 60 and the main component of the second metal paste 61 may be the same or different. A case where the main component of the first metal paste 60 and the main component of the second metal paste 61 are different is preferable in that different functions can be imparted to the first metal layers 21a and 21b and the second metal layers 22a and 22b.

The thickness of each of the second metal layers 22a and 22b can be adjusted by the amount of the second metal paste 61 applied. The number of times the second metal paste 61 is applied to adjust the thickness of each of the second metal layers 22 may be one or two or more.

In FIG. 24B, the second metal paste 61 is applied only to the end surface 10a side of the element body 10; however, the second metal paste 61 may be applied simultaneously to the end surface 10a side and the end surface 10b side of the element body 10. When the second metal paste 61 is applied simultaneously, it is necessary to dispose the second covering member 41 on each of the first metal layer 21a forming the metal base layer 20a and the first metal layer 21b forming the metal base layer 20b.

### <Step S32: Sintering Second Metal Paste>

FIG. 24C is a schematic plan view illustrating an example of the step of sintering the second metal paste in the metal base layer forming step of the method of manufacturing the multilayer ceramic electronic component according to the embodiment of the present disclosure.

In the step of sintering the second metal paste (step S32), the second metal paste 61 applied in the step of applying the second metal paste (step S31) is sintered.

The sintering temperature of the second metal paste 61 is not particularly limited and can be appropriately selected according to the composition of the second metal paste 61.

In a case where the main component of the second metal paste 61 is the same as that of the conductive paste used in the internal electrode pattern forming step (step S11), the sintering temperature can be the same as the firing temperature in the firing step (step S15). Further, the firing step (step S15) and the step of sintering the first metal paste 60 may be omitted, and the second metal paste 61 may be sintered simultaneously with the sintering of the element body 10 and of the first metal paste 60. In this case, the sintering conditions are the same as the firing conditions in the firing step (step S15).

In a case where the main component of the second metal paste 61 is a metal containing a glass component containing Si as a main component, the sintering temperature of the second metal paste 61 is preferably in a range of 600° C. to 1,000° C., and more preferably in a range of 700° C. to 900° C. In a case where the main component of the second metal paste 61 is Ni containing glass containing Ba as a main component, Cu containing glass containing Ba as a main component, Ni containing glass containing B as a main component, or Cu containing glass containing B as a main component, the sintering temperature of the second metal paste 61 is preferably in a range of 500° C. to 900° C., and more preferably in a range of 600° C. to 800° C.

FIG. 24D is a schematic plan view illustrating an example of a state in which the second covering member 41 is peeled off after the step of sintering the second metal paste in the metal base layer forming step (step S102) of the method of manufacturing the multilayer ceramic electronic component according to the embodiment of the present disclosure. FIG. 24E is a plan view illustrating an example of a state in which the first covering member 40 and the second covering member 41 are peeled off after the metal base layer forming step (step S102) is performed on the end surface 10a side and the end surface 10b side of the element body 10. As a result, the first metal layers 21a and 21b disposed on portions of at least one surface of the four surfaces 10c, 10d, 10e, and 10f of the element body 10, and the second metal layers 22 continuously covering regions extending from the end surfaces 10a and 10b of the element body 10 to portions on the end surface 10a side and the end surface 10b side of the first metal layers 21a and 21b and electrically connected to the internal electrode 12, are formed.

### (Step S103: Plating Layer Forming Step)

In the plating layer forming step (step S103), a pair of plating layers covering the pair of metal base layers are formed.

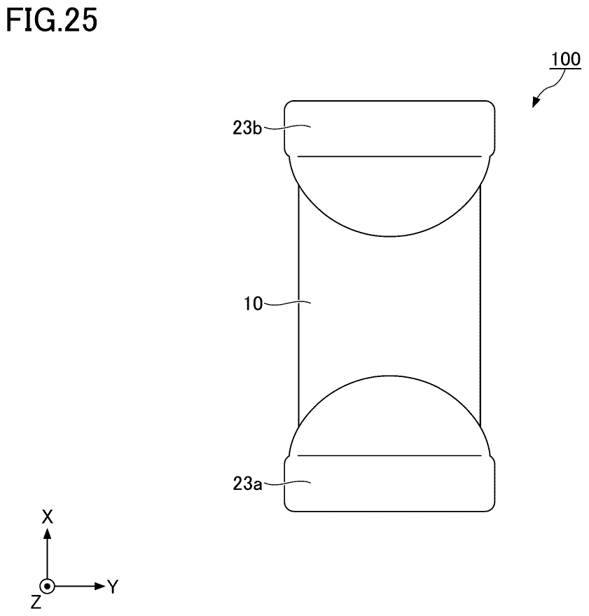

FIG. 25 is a schematic plan view illustrating an example of the plating layer forming step of the method of manufacturing the multilayer ceramic electronic component according to the embodiment of the present disclosure.

Plating layers 23a and 23b are preferably formed by plating. In the plating layer forming step (step S103), for example, it is preferable to perform plating by using a metal such as copper (Cu), nickel (Ni), or tin (Sn).

The first metal layers 21a and 21b, the second metal layers 22a and 22b, and the plating layers 23a and 23b form external electrodes 24a and 24b. More specifically, the first metal layer 21a, the second metal layer 22a, and the plating layer 23a form the external electrode 24a, and the first metal layer 21b, the second metal layer 22b, and the plating layer 23b form the external electrode 24b.

The metal base layer forming step (step S102) and the plating layer forming step (step S103) are performed such that, in a plan view of at least one surface of the element body 10 having the first metal layers 21a and 21b, outer edges of the plating layers 23a and 23b has curved shapes projecting from the end surface 10a side and the end surface 10b side to a center portion of the element body 10, and when an intersection point between each of the outer edges of the element body 10, facing in the second direction perpendicular to the first direction, and an outer edge of a corresponding one of the plating layers 23a and 23b is defined as an intersection point A, an intersection point between each of the outer edges of the element body 10 facing in the second direction and a boundary between a corresponding one of the first regions 21a-1 and 21b-1 and a corresponding one second regions 21a-2 and 21b-2 is defined as an intersection point A′, an imaginary straight line parallel to the first direction and passing through a midpoint, in the second direction, of the corresponding one of the plating layers 23a and 23b at a position where the corresponding one of the plating layers 23a and 23b has the maximum length L in the second direction is defined as an imaginary straight line f1, an outermost point of the corresponding one of the plating layers 23a and 23b on the imaginary straight line f1 on the element body 10 is defined as an outermost point B, and an intersection point between the imaginary straight line f1 and the boundary between the corresponding one of the first regions 21a-1 and 21b-1 and the corresponding one of the second regions 21a-2 and 21b-2 is defined as an intersection point B′, a linear distance E1 from the intersection point A to the intersection point A′ in the first direction and a linear distance E2 from the outermost point B to the intersection point B′ in the first direction satisfy Equation 1 below.

$$E 1 \neq E 2 \qquad Equation 1$$

In Equation 1 above, E1>0 and E2>0.

The multilayer ceramic capacitor 100 can be manufactured by the above-described steps.

The above-described steps are examples, and the method of manufacturing the multilayer ceramic capacitor according to the embodiment of the present disclosure is not limited to the above-described method.

### Other Embodiments

Although the embodiments have been described above in detail, the present disclosure is not limited to the specific embodiments, and various modifications and alterations can be made without departing from the scope of the present disclosure.

For example, the above-described embodiments are applied to a multilayer ceramic capacitor having two terminal electrodes; however, the present disclosure is applicable to a multilayer ceramic capacitor having three or more terminals.

Further, although the multilayer ceramic capacitor has been described as an example of the multilayer ceramic electronic component in the above embodiments, the present disclosure is applicable to various multilayer ceramic electronic components. Examples of such multilayer ceramic electronic components include a chip varistor, a chip thermistor, a multilayer inductor, and the like.

Aspects of the present disclosure are, for example, as follows.
<1> A multilayer ceramic electronic component includes:
an element body in which a plurality of internal electrodes and a plurality of dielectric layers containing a ceramic as a main component are alternately laminated, and that has a pair of end surfaces and four surfaces connected to the pair of end surfaces, wherein the pair of end surfaces face each other in a first direction and the plurality of laminated internal electrodes are alternately exposed at the pair of end surfaces;
a pair of metal base layers extending from the pair of end surfaces to portions of the four surfaces; and
a pair of plating layers covering the pair of metal base layers,
wherein each of the pair of metal base layers includes
   a first metal layer disposed on a portion of at least one surface of the four surfaces of the element body, and
   a second metal layer continuously covering a region extending from a corresponding one of the end surfaces of the element body to a portion on an end surface side of the first metal layer, and
wherein, in a plan view of the at least one surface of the element body having the first metal layer,
   the first metal layer has a first region covered by the second metal layer and a second region not covered by the second metal layer,
   an outer edge of a corresponding one of the plating layers has a curved shape protruding from an end surface side toward a center portion of the element body, and
   when an intersection point between each of outer edges of the element body, facing in a second direction perpendicular to the first direction, and an outer edge of the corresponding one of the plating layers is defined as an intersection point A, an intersection point between each of the outer edges of the element body, facing in the second direction, and a boundary between the first region and the second region is defined as an intersection point A′, an imaginary straight line parallel to the first direction and passing through a midpoint, in the second direction, of the corresponding one of the plating layers at a position where the corresponding one of the plating layers has a maximum length L in the second direction is defined as an imaginary straight line f1, an outermost point of the corresponding one of the plating layers on the imaginary straight line f1 on the element body is defined as an outermost point B, and an intersection point between the imaginary straight line f1 and the boundary between the first region and the second region is defined as an intersection point B′, a linear distance E1 from the intersection point A to the intersection point A′ in the first direction and a linear distance E2 from the outermost point B to the outermost point B′ satisfy Equation 1 below,

$$E 1 \neq E 2 \qquad Equation 1$$

where E1>0 and E2>0.
<2> The multilayer ceramic electronic component according to <1>, wherein the linear distance E1 and the linear distance E2 satisfy Equation 2 below,

$$E 1 < E 2 \qquad Equation 2$$

where E1>0 and E2>0.
<3> The multilayer ceramic electronic component according to <1> or <2>, wherein, in the plan view, when an outermost point on the end surface side of the corresponding one of the plating layers on the imaginary straight line f1 is defined as an outermost point D, a linear distance E3 from the intersection point B′ to the outermost point D satisfies Equation 3 below,

$$E 3 < E 2 \qquad Equation 3$$

where E3>0 and E2>0.
<4> The multilayer ceramic electronic component according to any one of <1> to <3>, wherein, in the plan view of the at least one surface of the element body having the first metal layer, a portion of an outer edge defining the second region has a curved shape projecting from a second metal layer side toward the center portion of the element body.
<5> The multilayer ceramic electronic component according to any one of <1> to <4>, wherein, in the plan view of the at least one surface of the element body having the first metal layer,
the second region includes a first exposed region and a second exposed region,
a portion of an outer periphery defining the first exposed region is the boundary between the first region and the second region, and another portion of the outer periphery defining the first exposed region has a curved shape projecting from a first region side toward the center portion of the element body, and
the second exposed region has a first intersection point G1 with the first exposed region and a second intersection point G2 with the first exposed region, and a portion of an outer periphery defining the second exposed region has a curved shape extending between the first intersection point G1 and the second intersection point G2 and projecting from the first exposed region toward the center portion of the element body.
<6> The multilayer ceramic electronic component according to any one of <1> to <5>, wherein an average thickness of the corresponding one of the plating layers located on the first metal layer is equal to an average thickness of the corresponding one of the plating layers located on the second metal layer.
<7> The multilayer ceramic electronic component according to any one of <1> to <6>, wherein, in the plan view of the at least one surface of the element body having the first metal layer, each of a shape of the first metal layer and a shape of the second metal layer is line-symmetric with respect to the imaginary straight line f1 serving as an axis of symmetry.
<8> The multilayer ceramic electronic component according to any one of <1> to <7>, wherein, in the plan view of the at least one surface of the element body having the first metal layer, when an imaginary straight line parallel to the second direction and passing through a midpoint of a maximum length W from an outermost point D on one end surface side of one of the plating layers on the imaginary straight line f1 to an outermost point D on an opposite end surface side of the other of the plating layers on the imaginary straight line f1 is defined as an imaginary straight line f2, a shape of an outer periphery of the one of the plating layers and a shape of an outer periphery of the other of the plating layers are line-symmetric with respect to the imaginary straight line f2 serving as an axis of symmetry.
<9> The multilayer ceramic electronic component according to any one of <1> to <8>, wherein
the first metal layer contains a metal that is same as a metal contained in the internal electrodes, and
the second metal layer contains a metal containing a glass component containing Si as a main component.
<10> The multilayer ceramic electronic component according to any one of <1> to <9>, wherein
the first metal layer contains a metal containing a glass component containing Si as a main component, and
the second metal layer contains a metal containing glass containing at least one of Ba or B as a main component.
<11> A method of manufacturing a multilayer ceramic electronic component, the method including:
preparing an element body in which a plurality of internal electrodes and a plurality of dielectric layers containing a ceramic as a main component are alternately laminated, and that has a pair of end surfaces and four surfaces connected to the pair of end surfaces, wherein the pair of end surfaces face each other in a first direction and the plurality of laminated internal electrodes are alternately exposed at the pair of end surfaces;
forming each of a pair of metal base layers extending from the pair of end surfaces to portions of the four surfaces; and
forming each of a pair of plating layers covering the pair of metal base layers,
wherein the forming of each of the pair of metal base layers includes
   forming a first metal layer on a portion of at least one surface of the four surfaces of the element body, and
   forming a second metal layer continuously covering a region extending from a corresponding one of the end surfaces of the element body to a portion on an end surface side of the first metal layer, and
wherein the forming of each of the pair of metal base layers and the forming of each of the pair of plating layers are performed such that, in a plan view of the at least one surface of the element body having the first metal layer,
   the first metal layer has a first region covered by the second metal layer and a second region not covered by the second metal layer,
   an outer edge of a corresponding one of the plating layers has a curved shape protruding from an end surface side toward a center portion of the element body, and
   when an intersection point between each of outer edges of the element body, facing in a second direction perpendicular to the first direction, and an outer edge of the corresponding one of the plating layers is defined as an intersection point A, an intersection point between each of the outer edges of the element body, facing in the second direction, and a boundary between the first region and the second region is defined as an intersection point A′, an imaginary straight line parallel to the first direction and passing through a midpoint, in the second direction, of the corresponding one of the plating layers at a position where the corresponding one of the plating layers has a maximum length L in the second direction is defined as an imaginary straight line f1, an outermost point of the corresponding one of the plating layers on the imaginary straight line f1 on the element body is defined as an outermost point B, and an intersection point between the imaginary straight line f1 and the boundary between the first region and the second region is defined as an intersection point B′, a linear distance E1 from the intersection point A to the intersection point A′ in the first direction and a linear distance E2 from the outermost point B to the outermost point B′ satisfy Equation 1 below,

$$E 1 \neq E 2 \qquad Equation 1$$

where E1>0 and E2>0.

As described above, although the present disclosure has been described based on the specific embodiments and examples, these embodiments and examples are merely examples, and the present disclosure is not limited to the above-described embodiments and examples. The above-described embodiments can be implemented in various other forms, and various combinations, omissions, substitutions, additions, modifications, and the like are possible without departing from the spirit of the present disclosure. These embodiments and modifications thereof are included in the scope and spirit of the present disclosure, and are also included in the claims and the equivalents thereof.

According to an embodiment of the present disclosure, a multilayer ceramic electronic component that can suppress excessive solder wetting and that can be fixed to a land part of a wiring pattern by soldering with an accurate mounting orientation and posture can be provided.

What is claimed is:

1. A multilayer ceramic electronic component comprising:
an element body in which a plurality of internal electrodes and a plurality of dielectric layers containing a ceramic as a main component are alternately laminated, and that has a pair of end surfaces and four surfaces connected to the pair of end surfaces, wherein the pair of end surfaces face each other in a first direction and the plurality of laminated internal electrodes are alternately exposed at the pair of end surfaces;
a pair of metal base layers extending from the pair of end surfaces to portions of the four surfaces; and
a pair of plating layers covering the pair of metal base layers,
wherein each of the pair of metal base layers includes
a first metal layer disposed on a portion of at least one surface of the four surfaces of the element body, and
a second metal layer continuously covering a region extending from a corresponding one of the end surfaces of the element body to a portion on an end surface side of the first metal layer, and
wherein, in a plan view of the at least one surface of the element body having the first metal layer,
the first metal layer has a first region covered by the second metal layer and a second region not covered by the second metal layer,
an outer edge of a corresponding one of the plating layers has a curved shape protruding from an end surface side toward a center portion of the element body, and
when an intersection point between each of outer edges of the element body, facing in a second direction perpendicular to the first direction, and an outer edge of the corresponding one of the plating layers is defined as an intersection point A, an intersection point between each of the outer edges of the element body, facing in the second direction, and a boundary between the first region and the second region is defined as an intersection point A′, an imaginary straight line parallel to the first direction and passing through a midpoint, in the second direction, of the corresponding one of the plating layers at a position where the corresponding one of the plating layers has a maximum length L in the second direction is defined as an imaginary straight line f1, an outermost point of the corresponding one of the plating layers on the imaginary straight line f1 on the element body is defined as an outermost point B, and an intersection point between the imaginary straight line f1 and the boundary between the first region and the second region is defined as an intersection point B′, a linear distance E1 from the intersection point A to the intersection point A′ in the first direction and a linear distance E2 from the outermost point B to the outermost point B′ satisfy Equation 1 below,
$$E 1 \neq E 2 \qquad Equation 1$$
where E1>0 and E2>0.

2. The multilayer ceramic electronic component according to claim 1, wherein the linear distance E1 and the linear distance E2 satisfy Equation 2 below,
$$E 1 < E 2 \qquad Equation 2$$
where E1>0 and E2>0.

3. The multilayer ceramic electronic component according to claim 1, wherein, in the plan view, when an outermost point on the end surface side of the corresponding one of the plating layers on the imaginary straight line f1 is defined as an outermost point D, a linear distance E3 from the intersection point B′ to the outermost point D satisfies Equation 3 below,
$$E 3 < E 2 \qquad Equation 3$$
where E3>0 and E2>0.

4. The multilayer ceramic electronic component according to claim 1, wherein, in the plan view of the at least one surface of the element body having the first metal layer, a portion of an outer edge defining the second region has a curved shape projecting from a second metal layer side toward the center portion of the element body.

5. The multilayer ceramic electronic component according to claim 1, wherein, in the plan view of the at least one surface of the element body having the first metal layer,
the second region includes a first exposed region and a second exposed region,
a portion of an outer periphery defining the first exposed region is the boundary between the first region and the second region, and another portion of the outer periphery defining the first exposed region has a curved shape projecting from a first region side toward the center portion of the element body, and
the second exposed region has a first intersection point G1 with the first exposed region and a second intersection point G2 with the first exposed region, and a portion of an outer periphery defining the second exposed region has a curved shape extending between the first intersection point G1 and the second intersection point G2 and projecting from the first exposed region toward the center portion of the element body.

6. The multilayer ceramic electronic component according to claim 1, wherein an average thickness of the corresponding one of the plating layers located on the first metal layer is equal to an average thickness of the corresponding one of the plating layers located on the second metal layer.

7. The multilayer ceramic electronic component according to claim 1, wherein, in the plan view of the at least one surface of the element body having the first metal layer, each of a shape of the first metal layer and a shape of the second metal layer is line-symmetric with respect to the imaginary straight line f1 serving as an axis of symmetry.

8. The multilayer ceramic electronic component according to claim 1, wherein, in the plan view of the at least one surface of the element body having the first metal layer, when an imaginary straight line parallel to the second direction and passing through a midpoint of a maximum length W from an outermost point D on one end surface side of one of the plating layers on the imaginary straight line f1 to an outermost point D on an opposite end surface side of the other of the plating layers on the imaginary straight line f1 is defined as an imaginary straight line f2, a shape of an outer periphery of the one of the plating layers and a shape of an outer periphery of the other of the plating layers are line-symmetric with respect to the imaginary straight line f2 serving as an axis of symmetry.

9. The multilayer ceramic electronic component according to claim 1, wherein
the first metal layer contains a metal that is same as a metal contained in the internal electrodes, and
the second metal layer contains a metal containing a glass component containing Si as a main component.

10. The multilayer ceramic electronic component according to claim 1, wherein
the first metal layer contains a metal containing a glass component containing Si as a main component, and
the second metal layer contains a metal containing glass containing at least one of Ba or B as a main component.

11. A method of manufacturing a multilayer ceramic electronic component, the method comprising:
preparing an element body in which a plurality of internal electrodes and a plurality of dielectric layers containing a ceramic as a main component are alternately laminated, and that has a pair of end surfaces and four surfaces connected to the pair of end surfaces, wherein the pair of end surfaces face each other in a first direction and the plurality of laminated internal electrodes are alternately exposed at the pair of end surfaces;
forming each of a pair of metal base layers extending from the pair of end surfaces to portions of the four surfaces; and
forming each of a pair of plating layers covering the pair of metal base layers,
wherein the forming of each of the pair of metal base layers includes
forming a first metal layer on a portion of at least one surface of the four surfaces of the element body, and
forming a second metal layer continuously covering a region extending from a corresponding one of the end surfaces of the element body to a portion on an end surface side of the first metal layer, and
wherein the forming of each of the pair of metal base layers and the forming of each of the pair of plating layers are performed such that, in a plan view of the at least one surface of the element body having the first metal layer,
the first metal layer has a first region covered by the second metal layer and a second region not covered by the second metal layer,
an outer edge of a corresponding one of the plating layers has a curved shape protruding from an end surface side toward a center portion of the element body, and
when an intersection point between each of outer edges of the element body, facing in a second direction perpendicular to the first direction, and an outer edge of the corresponding one of the plating layers is defined as an intersection point A, an intersection point between each of the outer edges of the element body, facing in the second direction, and a boundary between the first region and the second region is defined as an intersection point A′, an imaginary straight line parallel to the first direction and passing through a midpoint, in the second direction, of the corresponding one of the plating layers at a position where the corresponding one of the plating layers has a maximum length L in the second direction is defined as an imaginary straight line f1, an outermost point of the corresponding one of the plating layers on the imaginary straight line f1 on the element body is defined as an outermost point B, and an intersection point between the imaginary straight line f1 and the boundary between the first region and the second region is defined as an intersection point B′, a linear distance E1 from the intersection point A to the intersection point A′ in the first direction and a linear distance E2 from the outermost point B to the outermost point B′ satisfy Equation 1 below,
$$E 1 \neq E 2 \qquad Equation 1$$
where E1>0 and E2>0.
